(19) United States
(12) Patent Application Publication
(10) Pub. No.: US 2011/0276394 A1
(43) Pub. Date: Nov. 10, 2011

(54) Automated Targeted Information System

(75) Inventor: Jawe Chan, Pleasanton, CA (US)

(73) Assignee: PositionIQ, Inc., Pleasanton, CA (US)

(21) Appl. No.: 12/987,974

(22) Filed: Jan. 10, 2011

Related U.S. Application Data
(60) Provisional application No. 61/455,878, filed on Oct. 28, 2010.
(60) Provisional application No. 61/403,533, filed on Sep. 17, 2010.
(60) Provisional application No. 61/343,983, filed on May 5, 2010.

(51) Int. Cl. G06Q 30/00; G06F 17/30

(52) U.S. Cl. 705/14.49; 707/769; 707/722; 705/14.69; 705/26.7; 707/E17.014

(57) ABSTRACT

A method and apparatus for accessing information relating to an object is provided. The object can be found through a specification searching criteria derived from an identification code and/or specification of the consumer's computer. The object can be a mobile device, an accessory of mobile device, a mobile subscription plan, or promotion or coupon information of service or merchandise. The identification code can be used to identify the consumer's computer and/or its specification. The identification code of the computer device is used to supply the consumer with shopping information, product searching, product and/or service promotions, etc.

### CROSS-REFERENCE TO RELATED APPLICATIONS; PRIORITY CLAIM

This Non-Provisional Patent Application claims benefit of U.S. Provisional Patent Application No. 61/455,878, filed May 5, 2010; U.S. Provisional Patent Application No. 61/403,533, filed Sep. 19, 2010; and U.S. Provisional Patent Application No. 61/343,983, filed Oct. 28, 2010; the entire contents of each is hereby incorporated by reference as if fully set forth herein, under 35 U.S.C. §119(e).

### FIELD OF THE INVENTION

The present invention relates to accessing information using searching criteria derived from an identification code or a specification of a consumer computer system.

### BACKGROUND

The Internet is a revolutionary technology for accessing information. A consumer can access information around the world with a simple click of a mouse button. In light of society's popular acceptance of the Internet, the amount of information accessible via the Internet has been growing exponentially. For example, a consumer can receive a large amount of merchandise-related information using a shopping search engine. In many cases, the consumer only needs the merchandise information that is filtered based on search criteria derived from the consumer's computer identification or the consumer's computer specification. The information can be further used for shopping purposes.

From time to time, a consumer looks for merchandise such as a mobile computing device. In many cases, the reason why the consumer is looking is to replace the consumer's existing device. Mobile devices, mobile phones, and mobile phone accessories are most often promoted or sold by a wireless carrier associated with a wireless subscription plan and the actual sale of such a device normally conducted in a local retail store.

Most websites provide static pictures of the mobile devices or cell phones. They do not display any relationship between one or more known customer devices and the rest of the devices available on the website. For example, a subscribed consumer can login onto a cellular carrier's website and use the consumer's phone number to locate current the consumer's cellular phone model information. The cellular carrier has the consumer's information because the consumer is an existing customer. However, the website does not does not use any of the consumer's cellular phone model information for the consumer's shopping experience, such as a comparison between a candidate cellular phone feature and the cellular phone that the consumer currently owns. In this example, the consumer has a difficult time understanding or comprehending the value or feature set of a candidate cellular phone without the assistance of a live customer representative.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram of a server that stores and retrieves object data, according to possible embodiments of the present invention;

FIG. 2 illustrates an example of end-user computers communicating with a server, according to a possible embodiment of the present invention;

FIG. 3 illustrates an example block diagram of a computer system, according to a possible embodiment of the present invention;

FIG. 4 illustrates a user interface screen, according to a possible embodiment of the present invention;

FIG. 5 illustrates an example search results screen, according to a possible embodiment of the present invention;

FIG. 6 illustrates a user interface screen, according to a possible embodiment of the present invention;

FIG. 7 illustrates an example search results screen, according to a possible embodiment of the present invention;

FIG. 8 illustrates an example process flow, according to a possible embodiment of the present invention;

FIG. 9 illustrates an example process flow, according to a possible embodiment of the present invention;

FIG. 10 illustrates an example hardware platform on which a computer or a computing device as described herein may be implemented, according a possible embodiment of the present invention;

FIG. 11 illustrates an example comparison display screen, according a possible embodiment of the present invention;

FIG. 12 illustrates an example process flow of a server sending comparison specifications of merchandise of interest to a user computer, according to a possible embodiment of the present invention;

FIG. 13 illustrates an example process flow of a user computer displaying search result content from a server, according to a possible embodiment of the present invention;

FIG. 14 illustrates an example process flow of a user computer filtering search result content from a server, according to a possible embodiment of the present invention;

FIG. 15 illustrates an example process flow of a user computer displaying a list of search results content from a server, according to a possible embodiment of the present invention;

FIG. 16 illustrates an example process flow of a user computer displaying comparison search result content from a server, according to a possible embodiment of the present invention;

FIG. 17 illustrates an example process flow of a user computer displaying comparison search result content from a server, according to a possible embodiment of the present invention;

FIG. 18 illustrates an example process flow of a user computer displaying percentage improvement search result content from a server, according to a possible embodiment of the present invention; and

FIG. 19 illustrates an example process flow of a user computer displaying correlated search result content, according to a possible embodiment of the present invention.

### DESCRIPTION OF EXAMPLE POSSIBLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Example embodiments are described herein according to the following outline:
1. GENERAL OVERVIEW
2. EXAMPLE SYSTEM ARCHITECTURE
3. EXAMPLE PROCESS FLOW
4. AUTOMATIC PAGE FORMATTING FOR DIVERSE DEVICES
5. REVENUE GENERATION
6. EXAMPLE EMBODIMENTS
7. HARDWARE OVERVIEW
8. EQUIVALENTS, EXTENSIONS, ALTERNATIVES AND MISCELLANEOUS

### 1. General Overview

This overview presents a basic description of some aspects of a possible embodiment of the present invention. It should be noted that this overview is not an extensive or exhaustive summary of aspects of the possible embodiment. Moreover, it should be noted that this overview is not intended to be understood as identifying any particularly significant aspects or elements of the possible embodiment, nor as delineating any scope of the possible embodiment in particular, nor the invention in general. This overview merely presents some concepts that relate to the example possible embodiment in a condensed and simplified format, and should be understood as merely a conceptual prelude to a more detailed description of example possible embodiments that follows below.

In a possible embodiment, a system and method for accessing information relating to an object is provided. An object can be found through a specification searching criteria derived from a specification or/and identification code of a consumer computer. The object can be a mobile device, an accessory for a mobile device, a mobile subscription plan, promotion or coupon information of service or merchandise, or anything related to the consumer computer. The identification code can be used to identify the consumer computer and its specification, e.g., hardware description, such as: microprocessor, memory size/type, display screen type/resolution, whether the display screen is monochrome or color, color bit depth, keyboard specification, communication connection number/type, etc.; or software description, such as: operating system, applications native/added, etc. The identification code is selected from at least one the group consisting of: string of codes, IP (Internet Protocol) address, MAC (Media Access Control) address, host name, IMSI (International Mobile Subscriber Identity), TMSI (Temporary Mobile Subscriber Identity), IMEI (International Mobile Equipment Identity), TAC (Type Allocation Code), MEDI (Mobile Equipment Identifier), string of ASCII characters, serial number, FCC ID, model number, etc. The accessed information can be merchandise information specified by the user or advertisement information displayed to the user by a service provider.

In a possible embodiment, the specification of a computer can be automatically obtained. Advertisement(s) or search results (from a search criteria) can be customized and sent to the user's computer using the specification of the computer. The computer can be a mobile device, cell phone device, ebook device, gaming computing device, mobile accessory, any electronic device with a microcontroller/microprocessor, etc. The specification of the computer can be replaced by the identification code of the computer. In this case, the specification of the computer can be derived from the identification code of the computer by a server. In a possible embodiment, the specification of a computer includes the identification code of that computer.

In a possible embodiment, an advertisement can be displayed automatically to a user computer as a function of the specification of the computer or identification code of the computer. The advertisement can be in a form of electronic banner, text advertisement, email, text message, etc. The automation can be implemented by programming instructions that read the specification of the user computer, and may or may not include the identification code of the user computer.

In a possible embodiment, the results from a search criteria can be customized and sent automatically to the user's computer as a function of the specification of the computer or identification code of the computer. The specification or identification code of the user's computer can be part of the user's profile or computer profile, which may be part of the search criteria setup by the user.

In a possible embodiment, a mobile device manufacturer use an identification code (e.g., IMEI) to identify the model of the cellular phone. IMEI is made up of a TAC (Type Allocation Code) and a serial number called the SNR. The TAC identifies the phone manufacturer and model, and there can also be several different TACs for the same model phone. Prior to 2004, the TAC consisted of the first six digits of the IMEI, since then, the TAC has been allocated the first eight digits of the IMEI. The TAC is followed by a six digit SNR and a one bit checksum. This makes the IMEI a 15-digit number in recent phones and a 13-digit number in older (pre-2004) phones. A lookup table, a string of codes vs. mobile device model, or a mobile device specification, is available per mobile device manufacturer. With this lookup table, the mobile application software can send the string of codes to a server to retrieve the mobile device's specification. A featured mobile device (selected using promotional information) with similar or better specifications can be presented to the user using the mobile device specification.

In a possible embodiment, a mobile device manufacturer can use a unique string of codes, such as a MAC address, to identify a mobile device. The string of codes should not be limited to IMEI or MAC addresses.

In a possible embodiment, mobile device manufacturer can issue a coupon or discount or rebate whenever consumer is a repeat customer. In a possible embodiment, a repeat customer can send in the old IMEI, old phone number, and old carrier information to the mobile device manufacturer before switching to a new wireless plan or new phone in exchange for a coupon, discount, or a rebate. In a possible embodiment, a mobile device manufacturer can issue a discount based on the model of the phone to be replaced. The discount rate can vary. For example, the replacement of a high end phone receives a higher discount than a low end phone.

In a possible embodiment, the searching criteria system uses a search criteria derived from an identification code or specification of a computer system. Merchandise information can be linked to an on-line shopping system or a commercial product promotion system.

In a possible embodiment, the system provides information to upgrade a consumer's computer according to the current computer specification.

In a possible embodiment, the system promotes a replacement computer according to the consumer's current computer specification.

In a possible embodiment, a reward system can be implemented. After a consumer's information is found and the consumer has purchased the merchandise. The service provider that maintains the database or server can be paid a percentage of the purchasing price or paid a fixed amount. The seller, who may be the information provider, receives the remainder of the purchase proceeds from, for example, a pay service such as PayPal, a credit card company, etc.

In a possible embodiment, a pay-per-click method or system can also be further added. Commercial enterprises can profit through this infrastructure, in many cases by providing services that attach a small, incremental monetary value to a particular transaction.

In a possible embodiment, a pay-per-click search engine is provided. A user navigates to a search engine website and inputs the name of merchandise or services that he would like the pay-per-click company to find. Various providers of merchandise and services register their websites with the company. These are provided to the user in a list which is prioritized by the level of compensation which the merchant will give the pay-per-click company if the user is routed to their site. For example, using such a system, if a user types in “mobile phones,” the pay-per-click system might return some potential links, with the most prominent one being associated with the supplier of mobile phones that will compensate for a penny or a few cents more than the links presented below that link.

In a possible embodiment, a comparison specification may be returned to the consumer's computer. If the consumer's computer is a cellular phone, the specification of both of the phones may be compared in a side-by-side table format, or some of the specification can be overlaid visually, pictorially, or graphically in a display format. Moreover, the comparison specification of the replacement unit (if the consumer searches for a replacement phone) and the current cellular phone may be delivered to the consumer in any of the following formats: audio format, video display format, picture display format, text display format, etc. The comparison specifications may be defined but are not limited to any of the following: percentage of speed difference of the microprocessors, overlay of the form factor outline of the replacement and current computer, a comparison of operation system specifications, percentage increase of the replacement unit's memory size specification over the current unit, percentage increase of the replacement unit's memory speed specification over the current unit, percentage increase or decrease of dimension specification between the two units, percentage increase or decrease of weight specification between the two units, percentage difference of the color specification between the two units, benefit increase or decrease of the wireless subscription plan specification, percentage increase or decrease of the network connection speed specification between the two units, benefit of the different type of the network connection type specification between the two units, percentage of benefit of the display technology specification between the two units, percentage of increase or decrease of the display size specification between the two units, percentage of increase or decrease of the display resolution specification between the two units, percentage benefit of the software revision specification between the two units, increased area of the connection coverage availability specification, percentage benefit of the connection technology specification between the two units, percentage increase or decrease of the length of the battery consumption specification between the two units, percentage of the benefit of the camera resolution quality specification between the two units, etc. Again, the comparison specification search results, which are returned from server, may be derived from the specification of the following but are not limited to: the ID or specification of a consumer or user computer, the ID or specification of a computer that is stored in a user or consumer profile, the ID or specification of a consumer purchasing history or input by a input device, such as but not limit to: a camera or a USB pen, that communicates with the user's computer. The comparison specification may be delivered to a user computer in an advertisement format. In this case, the server may initiate the advertisement. The comparison specification advertisement, derive from an ID or specification mentioned, may be delivered to the user.

### Example System Architecture

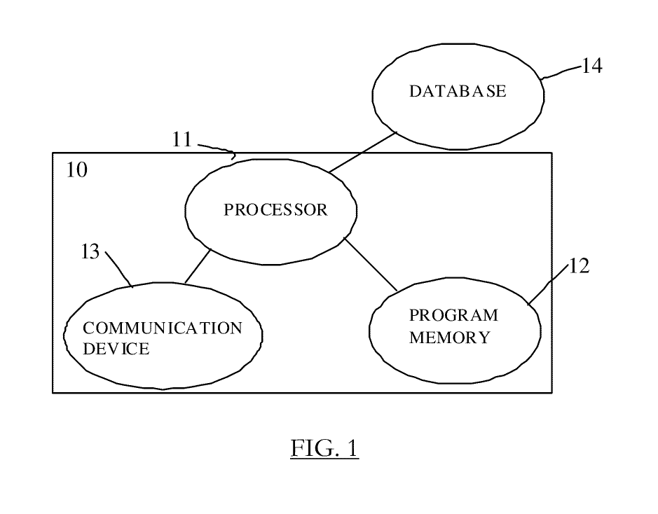

FIG. 1 illustrates a block diagram of a server 10 that stores and retrieves object data. Server 10 can include a processor 11, program memory 12, a communication device 13, and a database for objects 14. The communication device 14 may be a modem or a high-speed leased line router. In a possible embodiment, server 10 is an information server and processor 11 is in data communication with various end-user computer systems via the Internet. However, in other possible embodiments, the server 10 could be implemented with a processor 11 having multiple modems to receive calls directly from end-user computer systems and establishing data communication via the modems and public phone lines, e.g., POTS. The database 14 may include the promotion information for objects that includes, but is not limited to: e-coupons, coupons or product sales events, price of an object, an identification of an object, etc.

An example of a server 10 is a system operating in accordance with the Sun MicroSystems Solaris operating system, Linux, Microsoft Windows Server, etc. Processor 11 may be any general-purpose processor having a CPU, RAM, ROM, and I/O circuitry.

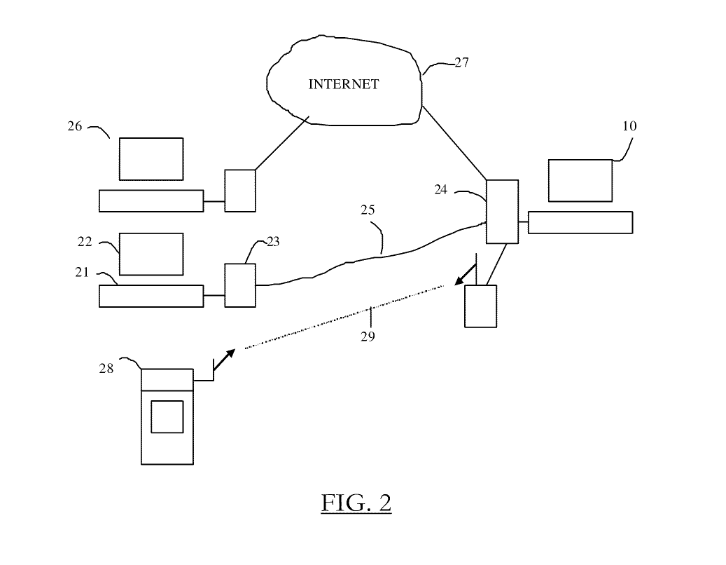

Referring to FIG. 2, end-user computers 21, 26, 28, communicate with server 10 in a variety of ways. In a possible embodiment, end-user computer system 21 connects to server 10 via modem 23 and modem 24 through phone line 25. In a possible embodiment, end-user computer 21 can be communicatively connected to a display device 22. In another possible embodiment, display device 22 may be incorporated within end-user computer 21. In a further possible embodiment end-user computer system 26 is also connected to server 10 through Internet 27. End-user computer system 28 connects to server 10 through radio frequency link 29.

A possible embodiment uses server 10 to access object information such as promotion information (e-coupon, coupon, product sales event, etc.) or business directory information in database 14 to provide a user with object promotion information. Database 14 can be a centralized database system that stores the data about object promotion information. However, in other possible embodiments, database 14 may be implemented as a distributed database system that stores the information in several computer systems and may be located in different geographical areas. Each of the distributed databases may store data about object information in a local area, such as a particular state, city, or country.

In a possible embodiment, database 14 may be implemented as a relational database, XML database, etc., using MySQL, PostgreSQL, Microsoft Access, SQL Server, FileMaker, Oracle, RDBMS, dBASE, Clipper, FoxPro, etc. Queries formed by server 10 are in a format corresponding to the database method being used by database 14. In other possible embodiments, database 14 may be implemented as a lookup table or a flat file. Computer IDs (identification code of the consumer's computer) and/or computer specifications can be searched for in database 14 in order to retrieve the object information that an end-user is looking for. Information for each computer is organized as a record in database 14 that describes the computer. Each record has at least the following searchable fields for each computer: computer ID (identification code of a computer) and computer specification.

In a possible embodiment, database 14 could also be associated with a promotions database. The promotions database can contain coupons or e-coupon information, or sales event information. For example, for a three-day car charger sales event, the car charger specification derived from a search of database 14 for the specification of a consumer's computer is sent to the consumer's computer and displayed on the display screen attached to the consumer's computer. The three-day sales price along with the start and stop limited sale date can also be displayed to the consumer. If there is a coupon sale for the car charger, the car charger coupon expiration date and discount can also be displayed to the consumer.

In a possible embodiment, database 14 could also be arranged in an object-oriented manner for attribute searching.

In a possible embodiment, database 14 can be configured to retrieve the relationship between the information of the computer or the mobile device collected and the target information to be accessed by the consumer. The targeted information to be accessed can be selected from one of the following group, repair service of the consumer computer, other information mention in this invention.

In a possible embodiment, specifications of items that are available for commercial transaction can be displayed to the consumer. Server 10 analyzes data associated with items that are available for commercial transaction in order to identify one or more specification attributes of the items and associates the identified specification attributes with the items in order to facilitate searchable parameters. Database 14 can be arranged in a manner that allows a search to be made between a consumer's computer specification and the associated specification attributes for the items. An identified item can be displayed based on a specification attribute of the item.

In a possible embodiment, server 10 can receive a criterion specifying a specification attribute and identify items that share a specification attribute with the specification attribute specified by the criterion. The items may be identified to a user, and if desired, the user may obtain an identified item in a commercial transaction. In a possible embodiment, a screen interface display may be supplied by the server 10 to the consumer's computer that is configured to receive a criterion specifying a specification attribute. Server 10 searches a catalog of items available for commercial transaction and identifies one or more items in the catalog based on the specification attribute specified by the criterion.

To facilitate the searching of items, database 14 may include one or more data structures for the items. The data structures may be prepared by analyzing items to identify specification attributes of the items, associating the identified specification attributes of the consumer computer with their respective items, and generating or updating one or more data structures for the items in which the specification attributes of the items are placed in a searchable field of the data structures. The data structures are searchable using a specification attribute, e.g., to identify specification related items.

In a possible embodiment, computer ID includes a string of codes. Computer ID could also, or alternatively, include any of: an Internet Protocol (IP) address, a Media Access Control (MAC) address, a host name, an International Mobile Subscriber Identity (IMSI), a Temporary Mobile Subscriber Identity (TMSI), an International Mobile Equipment Identity (IMEI), or a Mobile Equipment Identifier (MEID), a TAC (Type Allocation Code), a string of ASCII characters, a serial number, an FCC ID, and a model number.

In a possible embodiment, object specification includes, but is not limited to, one or more of the following: Operating System, Processor Speed, Memory Size, Memory Type, Dimension, Weight, Color, Style of the Object, Type of the Object, Subscription Plan, Network connection Speed, Network Connection Type, Display Technology, Display Size, Display resolution, Software Revision, Coverage Availability, Type of Battery, Camera Resolution Quality, Ability to be customized, Type of Keyboard, or GPS availability.

The following is an example of an object specification, where the object is a mobile device:

a. Type of Phone: flip phone, back flip

b. Operating System: Any Operating System for Mobile Phone 2.1

c. Processor: XYZ Brand 1 GHz mobile processor

d. Internal Memory: ROM 1 GB; RAM 576 MB

e. Compatibility: WiFi: 802.11b/g*GPS/AGPS

f. Email: One Exchange, up to 7 POP/IMAP

g. Dimensions: 123×68×10 mm

h. Weight: 157 g (with battery)

i. Display: 4.3-inch HD touch-sensitive screen with 480×800 WVGA resolution

j. Technology: GSM: 850/900/1800/1900 MHz WCDMA/HSPA: 1700 MHz (AWS)/2100 MHz.

In this example, the type of phone can include, but is not limited to, any of: flip phone, back flip, candy bar, smart phone, sliding keyboard, soft keyboard, etc. The Operating System can include, but is not limited to, any of: Any Operating System for Mobile Phone 2.1, IOS 4, Windows CE, Windows Phone, Android, etc.

In a possible embodiment, server 10 may send a portion of the database information in database 14 to an end-user computer 21, 26, 28. The end-user computer may have a local database manager that has the ability to search the portion of the database that it receives from the server 10. For example, server 10 may select the portion of the database information in database 14 using information such as the consumer's computer ID. The server 10 selects a portion of the information in database 14 that applies to the computer ID, e.g., the computer specification, any searchable items for commercial transactions, and advertisements, any other searchable information, etc. The server 10 sends the selected portion of the database to the consumer's computer. The consumer's computer can then perform information displays and searches locally in response to the consumer's commands and queries.

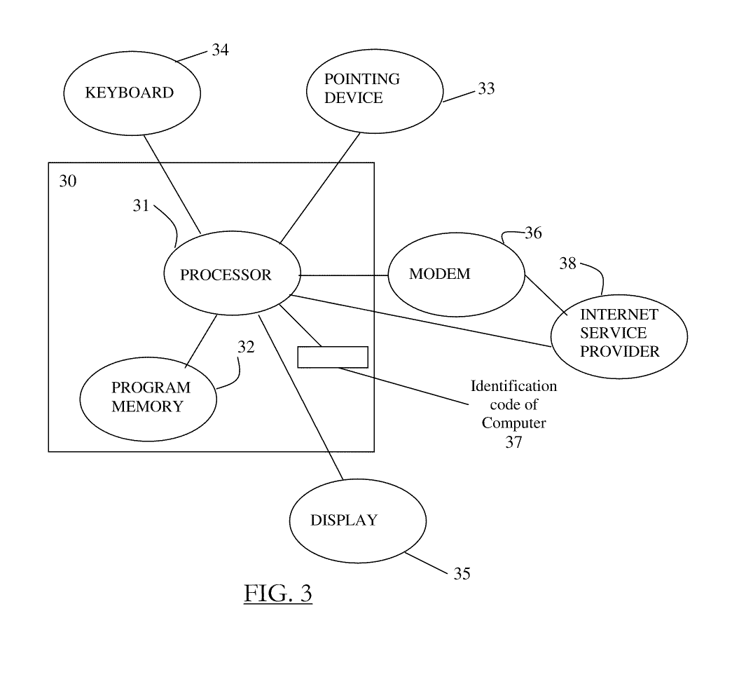

Referring to FIG. 3, a block diagram of an example end-user computer system is shown. Computer system 30 comprises a processor 31, program memory 32, a mouse 33 and keyboard 34 for user input, a display 35, a modem 36, and identification code of end-user computer system 37. A connection from computer system 30 to an Internet Service Provider (ISP) 38 is also shown. The connection may be via broadband, wired, wireless, satellite, POTS, DSL, ADSL, etc. In the environment of FIG. 2, system 30 is an end-user computer system, and processor 31 is in data communication with an Internet Service Provider 38. The Internet Service Provider 38 transmits the data to the server 10 via the Internet. In other possible embodiments, the system could be implemented with a processor 31 having a modem 36 calling directly to the server 10 and establishing the data communication link via the modem 36. Alternatively, the system could be implemented such that the end-user computer system 30 and server 10 are connected via a local network.

In a possible embodiment, the network includes a data network based on an Internet Protocol (IP). In another possible embodiment, the network includes a wired Local Area Network (LAN) such as an Ethernet LAN. In one embodiment, the network includes a Wireless Local Area Network (WLAN). In yet another possible embodiment, the network includes a Wide Area Network (WAN). In another possible embodiment, the network includes a public data network, such as a WiFi hotspot network, or a cellular data network such as General Packet Radio Service (GPRS) network. In a possible embodiment, the network includes a private data network such as a home network, a corporate network, a regional corporate network or a corporate Virtual Private Network (VPN). In another possible embodiment, the network includes a service provider network.

The ID code of end-user computer 37 is resident in the hardware of end-user computer 30. End-user computer system 30 can send the end-user computer ID 37 to server 10. Alternatively, the end-user of end-user computer system 30 can input the ID code from another input device, for example from a keyboard 34, if the user knows the computer ID or would like to search for object information using another computer ID.

An example of a suitable end-user computer system 30 is one operating in accordance with the Microsoft operating system, Apple Mac OS, Linux, etc. Processor 31 may be any general-purpose processor having a CPU, RAM, ROM, and I/O circuitry. Other input devices instead of, or in addition to, mouse 33 and keyboard 34 could be used, such as trackballs, touch pads, graphic tablet, or joysticks. The processor 31 is programmed to execute a process to help the user and accept and process the user's input.

### Example Process Flow

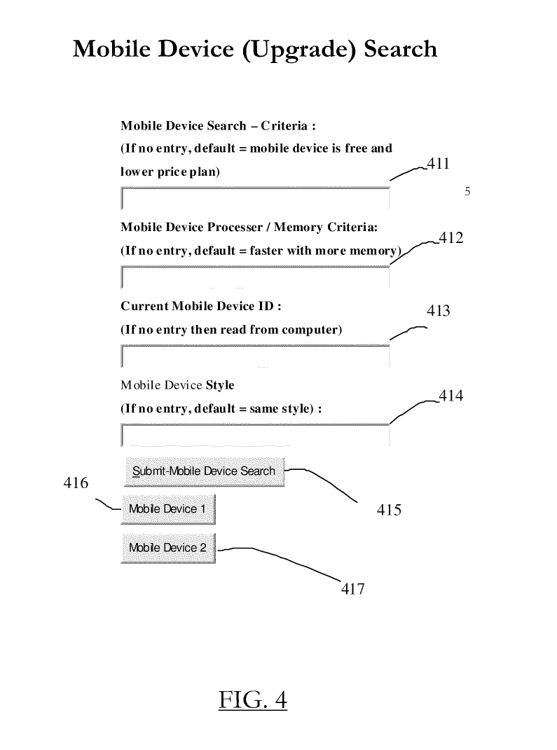

FIG. 4 illustrates an example graphical user interface. The graphical user interface can be formatted for display on display 35. There are several input boxes and buttons on the graphical user interface configured to accept input from the user.

Data entry area 413 accepts input for a computer ID. The ID is an identification code to identify a computer's specification, based on that, the user can retrieve the information or the server can send the information (e.g., promotional information) to the end-user computer. The identification code of the end-user computer can be Mobile Equipment Identifier (MEID). If the user doesn't know the MEID of the end-user computer, the user could let application software resident on the user's computer retrieve the information (alternatively, this can be a default setting). The user could choose MEID as the default setting by leaving data entry area 413 empty. The current MEID is stored in program memory 32. It could be a string of hexadecimal numbers or string of codes as discussed above. By default, the MEID is chosen unless the user inputs other ID numbers in the data entry area 413.

Data entry area 411 accepts user input for a mobile device and search criteria. The default setting of this data entry area can be “free of charge on mobile device with a 2 year contract and wireless price plan is lower in cost than current plan”. Data entry area 412 accepts input for the target mobile device specification. The default setting of data entry area 412 can be “faster processor with more memory compared to the current mobile device”. Processor 31 receives the user data input from the search input entry area 412.

Data entry area 414 accepts input for the mobile device style. In a possible embodiment, mobile device style signifies the keyboard style, either a soft keypad style or hard keypad style. In a possible embodiment, processor 31 is able to differentiate the different mobile device styles that a user can enter, for example, the programming style, flip phone style or touch screen style, the color of the phone, the dimensions of the mobile device, etc. An API or software routine run by processor 31 can classify the user's input and decide what the user means by his data input.

Button 415 is the “submit button” for the user to click (or touch). The user can click or touch the button to submit the search criteria. Selectable buttons 416, 417 are the memory recall buttons to recall the phone information from a previous input or a previous search. The user can recall the phone information by clicking either the memory recall button 416 or 417.

Processor 31 organizes the received input, end-user computer id, mobile device and search criteria, and mobile device processor and memory criteria, mobile device style criteria, as a message packet or database query. In a possible embodiment, processor 31 sends the information to the server via Internet Service Provider 38 using, for example, a modem 36, phone line, cable modem, DSL modem, etc. The Internet Service Provider 38 further transmits the information to server 10. After receiving the information at server 10, processor 11 forms the search query and queries database 14.

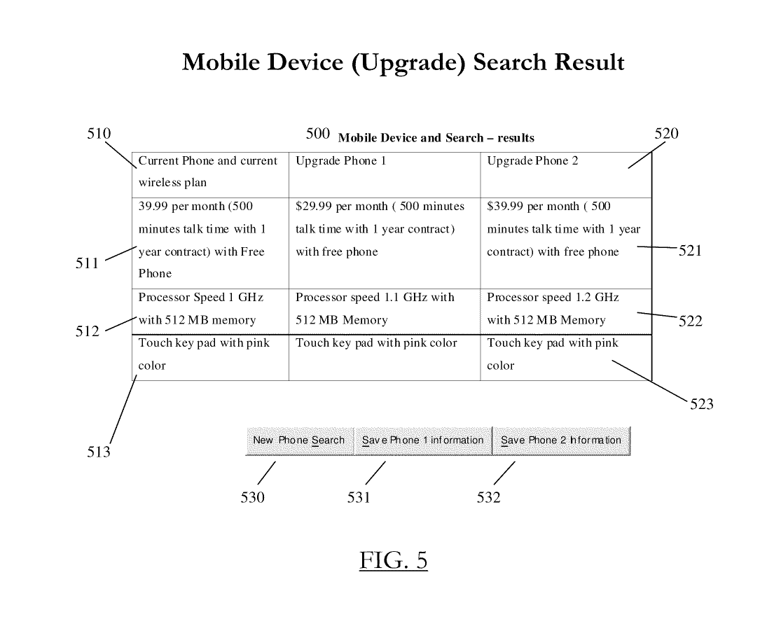

Referring to FIG. 5, processor 31 receives the search results and displays the results 500 to the user. Search results table 500 includes a display field 510 for the current phone identification and current phone wireless plan, a display field 511 for the current phone's price structure with the wireless subscription plan, a display field 512 for the current phone's processor specification and memory specification, and a display field 513 for the current phone's style.

The search results table 500 also includes information that displays the search results. Fields 520, 521, 522, 523 display results that match the search criteria. Field 520 displays the identifier of a phone. Field 521 displays the price of the new phone with new subscription plan. The field 522 displays the specification of the new phone. The field 523 displays the style of the new phone. In a possible embodiment, the specification of the new phone may be visually or statistically compared in a percentage at a glance manner to the specification of the user's current phone in the search results table, e.g., the microprocessor speed of the new phone can be displayed as being 20% faster than the microprocessor of the current phone, etc. The displayed percentage may be represented as a numeric value, bar graph, line graph, color indication, etc. In a possible embodiment, this result can be periodically updated, e.g., it can be updated every month, every day, hourly, multiple hour intervals, etc. This may depend on the availability of a new phone that matches with the user's search criteria, which is derived from the specification of the current phone. The result may be updated and an alert issued to the user, e.g., if a new phone is introduced that is 25% faster in CPU speed, etc. The result may be periodically updated without a set condition. An alert message might send to the user if the search criteria are met.

The user can click on button 530, if the user would like to start a new search. It will cause the display to display the screen in FIG. 4, for example. Button 531 saves the phone 1 search result information. The user can save the phone 1 information in local memory on computer system 30 by selecting this button. The user can retrieve the information at a later time. Button 532 saves the phone 2 search result information. The user can save the phone 2 information in local memory on computer system 30 by selecting this button. The user can retrieve the information at a later time.

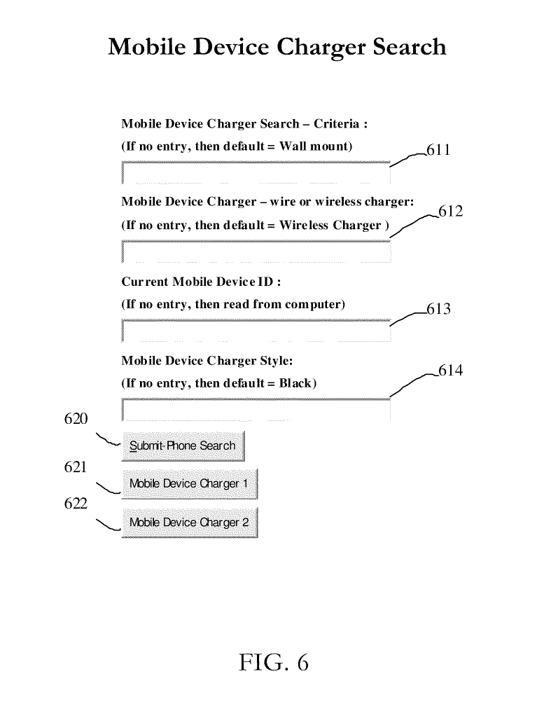

Referring to FIG. 6, another example graphical user interface is shown. In a possible embodiment, the graphical user interface is a form formatted for display on display 35. There are several input boxes and buttons on the graphical user interface to accept input from the user. Data entry area 613 accepts input for a computer ID. The ID is an identification code to identify a computer's specification, based on the ID, the user can retrieve the information or the server can send the information (e.g., promotional information) to the end-user computer. The identification code of the end-user computer can be Mobile Equipment Identifier (MEID). If the user doesn't know the MEID of the end-user computer, the user could let application software resident on the user's computer retrieve the information (alternatively, this can be a default setting). The user could choose MEID as the default setting by leaving data entry area 613 empty. The current MEID is stored in program memory 32. It could be a string of hexadecimal numbers or string of codes as discussed above. By default, the MEID is chosen unless the user inputs other ID numbers in the data entry area 613.

Data entry area 611 accepts input for a mobile device charger and search criteria. The default setting of this box can be “wall mount charger”. Data entry area 612 accepts input for a type of charger, e.g., wired or wireless. The default setting of data entry area 612 can be “wireless charger” if the user does not enter any data into data entry area 612. Processor 31 receives the user data input from data entry area 612.

Data entry area 614 accepts user data input for the mobile device charger style. In a possible embodiment, the mobile device charger style is black or white. In a possible embodiment, the mobile device style can be any color such as pink or blue.

Button 620 is the “submit button” for the user to click (or touch). The user can click or touch the button to submit the search criteria. Button 621 and button 622 are the memory recall buttons used to recall the mobile device charger information from a previous input or a previous search. The user can recall the mobile device charger information by clicking either the memory recall button 621 or 622.

Processor 31 organizes the received input, end-user computer id, mobile device charger and search criteria, mobile charger type, mobile device charger style criteria, as a message packet or database query. In a possible embodiment, processor 31 sends the information to the server via Internet Service Provider 38 using, for example, a modem 36, phone line, cable modem, DSL modem, etc. The Internet Service Provider 38 further transmits the information to server 10. After receiving the information at server 10, processor 11 forms the search query and queries database 14.

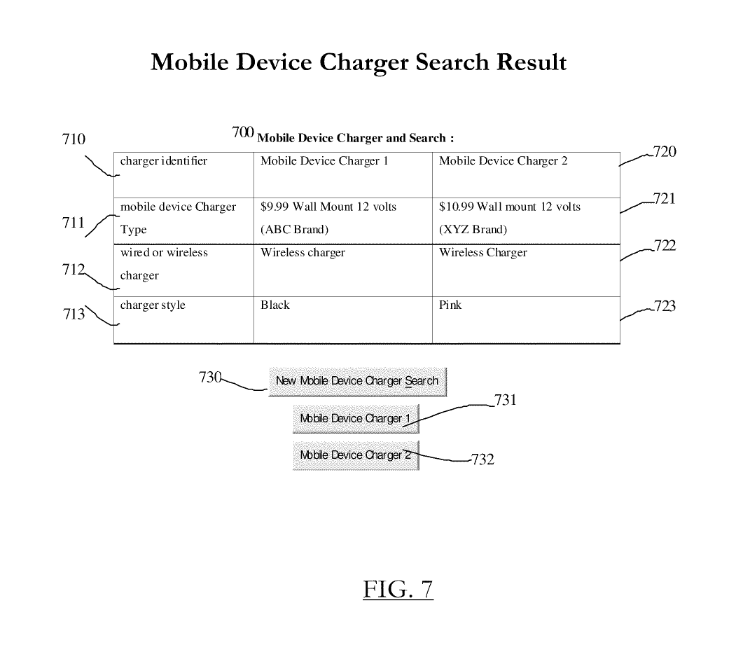

Referring to FIG. 7, processor 31 receives the search results and displays the results as 700 to the user. Search results table 700 includes a display field 710 for the charger identifier, a display field 711 for the mobile device charger type, a display field 712 to indicate if the charger is a wired charger or a wireless charger, and a display field 713 for the mobile charger style.

The search results table 700 also includes information that displays the results. Fields 720, 721, 722, 723 display results that match the search criteria. The field 720 displays the identifier of a mobile charger. Field 721 displays the price of the mobile charger and the voltage rating. The field 722 displays whether the mobile device charger is a wireless charger or a wired charger. The field 723 displays the style of the mobile charger that includes the color.

Button 730 is the new search button. The user can click on the button to start a new mobile device charger search. It will cause the display to display the screen in FIG. 6, for example. Button 731 saves the mobile charger 1 information. The user can save the mobile charger 1 information in local memory on computer system 30 by selecting this button. The user can retrieve the information at a later time. Button 732 saves the mobile charger 1 information. The user can save the mobile charger 2 information in local memory on computer system 30 by selecting this button. The user can retrieve the information at a later time.

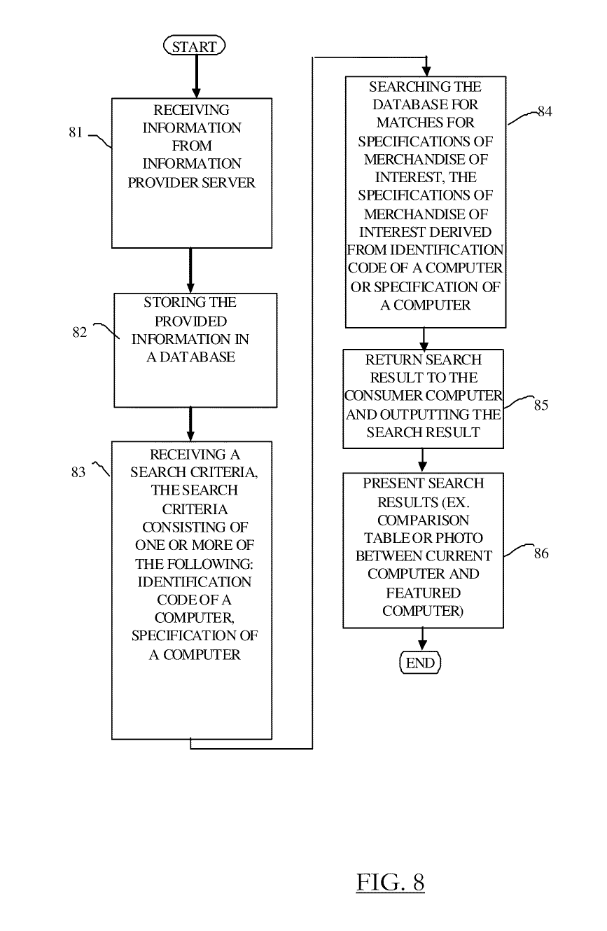

Referring to FIG. 8, an example process flow chart is shown illustrating a server performing searches for merchandise related to a computing device's ID or specification. At step 81, the server 10 or a database manager receives computer device and merchandise information from computer device/merchandise manufacturers, distributors, and/or retailers. The computer device information includes information needed to populate the database with computer ID and specification information. The server 10 receives the information from the computer device/merchandise manufacturers, distributors, and/or retailers via an Internet connection, phone line, radio frequency link, etc. The computer device and merchandise information may be any combination of: manufacturer specification, operation system specification, micro processor speed specification, memory size specification, memory type specification, dimension specification, weight specification, color specification, style specification, wireless subscription plan specification, network connection speed specification, network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

The computer ID and specification information is correlated with merchandise object information received from the computer device/merchandise manufacturers, distributors, and/or retailers by the server 10. Server 10 can perform the correlation using local memory or can store the information (step 82) in data structures, such as tables, in database 14.

At step 83, server 10 receives search criteria such as an ID code for a consumer computer or a specification of a consumer computer from a consumer's computer. The server 10 forms a query for database 14 using the search criteria. Server 10 then submits the query to database 14. Database 14 finds any merchandise that has been correlated to match the search criteria, for example, candidate cellular phones, car chargers, cellular phone cases, earphones, etc.

At step 85, the server 10 receives the search results from database 14. Server 10 formats the search results in a message to the consumer's computer. The message may take many forms, e.g., a formatted HTML page, a bitmap picture, a customized or standard message packet, etc. The server 10 sends the message to the consumer's computer.

At step 86, the consumer's computer receives the message from the server 10 and displays the search results to the consumer. The consumer's computer may format a screen using the search results, display a bitmapped page, display an HTML page, etc. In a possible embodiment, the consumer can purchase any of the merchandise shown in the search results by clicking on a purchase button near the merchandise description. In a possible embodiment, a link (e.g., URL, hyperlink, etc.) may be displayed along with the merchandise description that the consumer may click on to obtain more information about the merchandise.

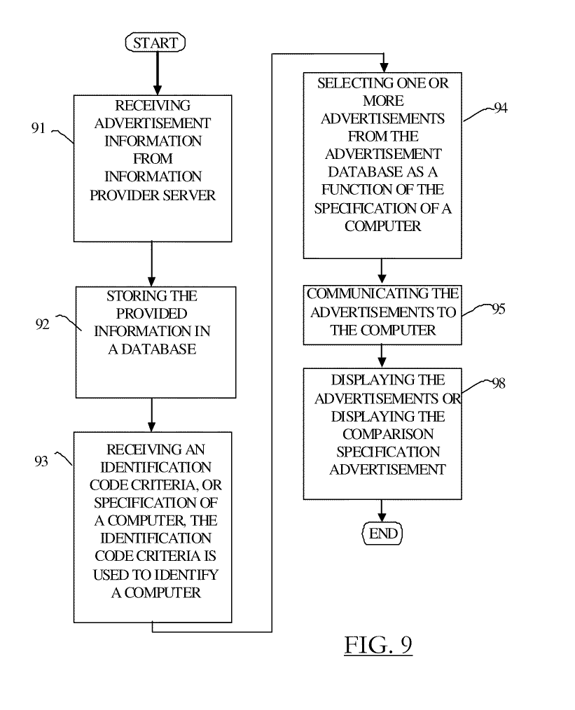

Referring to FIG. 9, an example process flow chart is shown illustrating a server performing searches for advertisements related to a computing device's ID or specification. At step 91, the server 10 or a database manager receives advertisement information from computer device/merchandise advertisers, manufacturers, distributors, and/or retailers. The advertisement information includes information needed correlate the advertisement information with the computer ID and specification information in the database. The advertisement information may also include geographic information that may restrict or exclude advertisements to certain geographic areas, for example. The server 10 receives the information from the computer device/merchandise advertisers, manufacturers, distributors, and/or retailers via an Internet connection, phone line, radio frequency link, etc.

The advertisement information received from the computer device/merchandise manufacturers, distributors, and/or retailers is correlated with computer ID and specification information by the server 10. Server 10 can perform the correlation using local memory or can store the information (step 92) in data structures, such as tables, in database 14.

At step 93, server 10 receives search criteria such as an ID code for a consumer computer or a specification of a consumer computer from a consumer's computer. The server 10 forms a query for database 14 using the search criteria. The query may take any form that is compatible with the database mechanism used, e.g., SQL query, etc. Server 10 then submits the query to database 14. Database 14 finds any advertisements that have been correlated to match the search criteria, for example, service advertisements, upcoming product advertisements, advertisements for current products with links for the consumer to click on, etc.

At step 95, the server 10 receives the search results from database 14. Server 10 formats the search results in a message to the consumer's computer. The message may take many forms, e.g., a formatted HTML page, a bitmap picture, a customized or standard message packet, etc. The server 10 sends the message to the consumer's computer.

At step 96, the consumer's computer receives the message from the server 10 and displays the search results to the consumer. The consumer's computer may format a screen using the search results, display a bitmapped page, display an HTML page, etc. In a possible embodiment, the consumer can purchase any of the merchandise shown in the search results by clicking on a purchase button near the advertisement. In a possible embodiment, a link may be displayed along with the advertisement that the consumer may click on to obtain more information about the subject of the advertisement.

Note that all of the operations and/or modules described herein may be implemented, individually or in any combination, in software programs, hardware, or any combination of software and hardware.

The system allows consumers to shop without having to log onto a carrier's website. Consumers are able use information readily at hand, such as the identification code of the consumer computer or its specification, to shop for similar or better computer or mobile devices.

### Automatic Page Formatting for Diverse Devices

In a possible embodiment, server 10 receives computer IDs and specifications from a consumer's computer when a consumer searches for merchandise, advertisements, etc. The server 10 can search for the hardware and software specifications of the consumer's computer in database 14. With the consumer's computer hardware and software specifications, the server 10 has the ability to automatically customize the search results for the consumer's computer.

In a possible embodiment, server 10 prepares a display page formatted for the specific hardware and software configuration of the consumer's computer. For example, the server 10 finds that the consumer's computer is a cellular phone with a gray scale having a screen resolution of 320×200 pixels. The search results include a color JPEG picture of a featured cellular phone as well as specifications for two cellular phones. The server 10 scales the JPEG picture to fit the 320×200 pixel screen and converts the JPEG picture to gray scale. The server 10 also formats the specification information for the two cellular phones to fit in a table form, possibly as shown in FIG. 7. The server 10 formats the table to fit in a 320×200 pixel screen. It creates an HTML page to display the formatted table and the scaled and converted JPEG picture. It then sends the page to the consumer's computer.

In another example, the server 10 finds that the consumer's computer is a desktop PC with a 16-bit color display having screen resolution of 1024×768 pixels. The search results include a JPEG picture of a featured PC as well as specifications for four PCs. The server 10 scales the JPEG picture to fit in the 1024×768 pixel resolution and 16-bit color range. The server 10 also formats the specification information for the four PCs to fit in a table form. The server 10 formats the table for the 1024×768 pixel resolution. It creates an HTML page to display the formatted table and JPEG picture and sends the page to the consumer's computer.

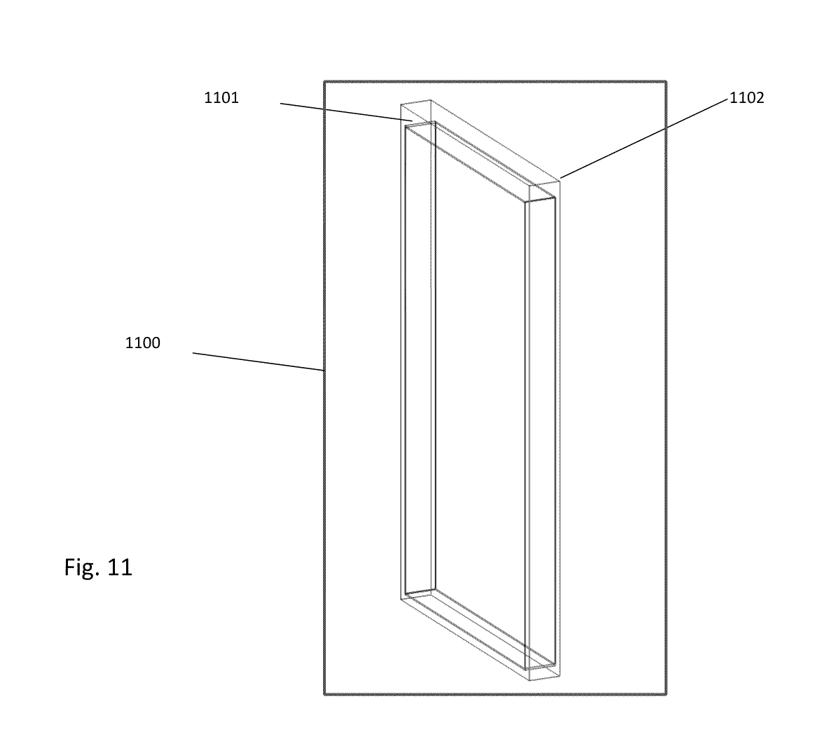

The server 10 can automatically adapt search results output and advertisements to any consumer computer because the computer's specifications are stored in database 14. referring to FIG. 11, server 10 may scale a comparison display using, e.g., a JPEG picture, TIFF picture, etc., to show the consumer a comparison of the size of the consumer's present computer or larger hardware system associated with the consumer's computer, e.g., a cellular phone, automobile, desktop computer, etc. For example, if the consumer's computer is a cellular phone, a comparison display may be scaled for the consumer's computer screen 1100. The display may include a depiction of the consumer's cellular phone 1101 and a suggested replacement cellular phone 1102. The outline of both of the cellular phones can be visually, pictorially, or graphically overlaid on top of each other on a display. The display may also include a rotate and/or zoom capability. The specification of both of the phones may be compared side by side in a table format, or can be overlaid in the display format. Moreover, the comparison specification of the replacement and the current cellular phone may be delivered to the consumer in any of the following formats: audio format, video display format, picture display format, text display format, etc.

In a possible embodiment, the server 10 can create different resolution pages that adapt to the connection bitrate of the consumer's computer in order to make the transfer of the search information to the consumer computer more efficient. For example, the server 10 may find that the consumer's computer is a cellular phone on a data network using 3G technology. The server 10 formats the resolution of the search results HTML page to take as little bandwidth as possible in order to give the consumer a better user experience.

### Revenue Generation

In a possible embodiment, server 10 as the ability to record which advertisements are sent to a consumer's computer. The server 10 can charge an advertiser a fee for every advertisement sent out to consumers' computers using an accounting software package. Alternatively, the server 10 can notify an accounting server of advertisements sent to consumers' computers. The accounting server can charge fees to advertisers based on, for example, the number of times the advertiser's advertisements are sent out.

In a possible embodiment, the consumer's computer acts in conjunction with server 10 to record advertisement views, link click-throughs, search result selections, etc. The consumer's computer records which of the search results the consumer selects. The consumer's computer can also record whether the consumer selects or views any advertisements sent by the server 10. The server 10 receives information from the consumer's computer indicating which search results were selected by the consumer and, in addition to or alternatively, any advertisements selected or viewed by the consumer. The server 10 can charge the subject of the selected search result (e.g., a service) a fee for being selected by the consumer using an accounting software package. The server 10 could charge an advertiser a fee for every advertisement selected or viewed by consumers. Alternatively, the server 10 can notify an accounting server of selected search results. The accounting server can charge fees to the subject of each selected search result. Server 10 could notify an accounting server of advertisement selected or viewed by consumers. The accounting server can charge fees to advertisers based on, for example, the number of times the advertiser's advertisements are selected or viewed.

In a possible embodiment, the server 10 or an accounting server may charge an advertiser a fee for preferential selection of advertisements for a specific geographical area. The server 10 will select the advertiser's advertisement(s) for a certain number of queries, for example, that originate from a certain geographical area.

### Example Embodiments

In a possible embodiment, the system delivers information to a user, based on the specification or ID of the object that interacts with the user, where a portion of the information is derived from the specification or ID of the object that is not manually input by the user. The information can be related to one of the following information group consisting of: merchandise information (including, but not limited to: the information or the price information related to a vehicle or an auto part, information or price information related to a mobile device, information or price information related to an object equipped with a computer, information or price information related to a component or a tool to build an object equipped with a computer), advertisement information (including, but not limited to: advertisement information or on sale information related to a vehicle or an auto part, advertisement information or on sale information related to a mobile device or an accessory of a mobile device, advertisement information or on sale information related to an object equipped with a computer, information of on sale information related to a service to an object equipped with a computer (e.g., an auto repair service, etc.)), and service information (including, but not limited to: service information, repair information, or service/repair labor cost information related to a vehicle, service information or wireless plan service related to a mobile device, service information, repair information, or service/repair labor cost information related to an object equipped with a computer).

In a possible embodiment, the object is associated with a larger hardware system, such as a vehicle, e.g., car, motorcycle, boat, ship, airplane, etc. The hardware specification information can be retrieved from the license plate number or VIN (Vehicle Identification Number) of the vehicle that the user is interacting with. The information can also be retrieved from the ID or specification of the mobile device installed in the vehicle. In one possible embodiment, the user can obtain the license plate number or VIN from images, e.g., a picture, a photo, etc., of the vehicle's license plate from a mobile device, e.g., a cell phone equipped with camera, a camera with a wireless connection, etc. The mobile device can transfer the image to the object in the vehicle via, for example, a wireless connection such as Bluetooth or 802.xx, a media card such as an SD card or USB pen drive, etc. The information from the image might be obtained using, for example, OCR (Optical Character Recognition) or any process that converts images of text into characters. After conversion, the license plate number or VIN can be used as the ID or specification of the vehicle. The mobile device could perform the OCR on the image before sending the text information the server 10 or the server 10 can perform the OCR upon receipt of the image from the mobile device.

In a possible embodiment, the license plate number or VIN of the vehicle can be obtained from a user profile, which is stored in a database. In that case, the search result is derived from the user profile which stores the ID or specification of an object (in this example, a vehicle).

Upon receipt of the vehicle ID or specification, the server 10 searches the database 14 for the ID or specification. The information that the database 14 returns includes information about the associated vehicle. The information comprises details about the vehicle that the server 10 can use to find merchandise information, advertisements, and/or service information related to the vehicle. For example, the information returned from a search could include the following:

a. Type of Vehicle: 2010 XYZ brand 4 door sedan.

b. Operating System: Any operating system for the computer installed in the automobile.

c. Horse Power: 210 horse power.

d. Engine: 6 cylinder, 2000 CC

In a possible embodiment, the user can shop for a vehicle that is similar to the vehicle from which the user has initiated the inquiry. The server 10 searches the database 14 for vehicles with similar information as the vehicle from which the user has initiated the inquiry. The server 10 returns the search results to the object in the vehicle which displays the results in some manner to the user.

In a possible embodiment, the system allows a user to search for replacement parts for a vehicle. In one possible example, the user can shop for brake pads associated with the vehicle. The server 10 may query the database 14 for brake pads for the vehicle using the ID or specification supplied by the object in the vehicle. The information returned from the search may include the following:

Brake Pad Specification:

Part Number: MKD465A (ABC Brake Brand for XYZ car Brand)

Weight: 3.1 lbs

Warranty: Limited Lifetime

Notes: Semi-metallic

Friction Material Type: Platform specific friction

Wear Sensor: Yes

Friction: No

In a possible embodiment, the user can search for a service or repair service, possibly including the labor cost, of the hardware that the user interacts with or is interested in. In a possible embodiment, the user can shop for an installation service that will install the brake pads related to the vehicle.

In a possible embodiment, the user can search for DYI (Do-It-Yourself) and “how to” service/installation/repair information related to the hardware that the user interacts with or is interested in. In a possible embodiment, the user can search for information about “how to install brake pads” related to the vehicle. The “how to” information might consist of, but is not limit to, the following: the price of the tool, type of tool, the dimensions (metric or SAE) of the screws/washers, type of lubricants needed to install brake pads. The “how to” information might include the price of any associated tools or any other components that are needed to install the necessary component or perform the necessary service.

In an example scenario, a user interacts with an onboard computer in a 2007 XYZ automobile. The automobile has a factory cellular telephone that the onboard computer uses to access the Internet and a server (for example, like server 10 described above). The user initiates a search for a service to perform an oil change on the automobile. The onboard computer has been programmed by the factory with the automobile's VIN number. The onboard computer sends the VIN number to the server and the request for an oil change service.

The server receives the VIN number and the request for an oil change service from the onboard computer. The server uses the VIN number to search the database for the automobile information. The database returns the following information:

a. Type of Vehicle: 2007 XYZ brand sport coupe.

b. Operating System: Windows CE.

c. Horse Power: 300 horse power.

d. Engine: 6 cylinder, 3500 CC

The server then searches the database for an XYZ oil change service center. The server may also search the database for advertisements for oil change services for the XYZ automobile. The server returns the search results for oil change service centers (and possibly the advertisements from the advertisement search) to the onboard computer.

The onboard computer displays the oil change service center search results to the user (and possibly any advertisements received from the server). The onboard computer can offer the user the option of selecting an oil change service center and displaying directions and/or a map for the oil change service center. The onboard computer can monitor which oil change service center the user selects (possibly via monitoring the navigation system or the simple selection from the search results). The onboard computer can inform the server or a monitoring service of the oil change service center selected by the user. The server, accounting system, or monitoring service may then charge the oil change service center a fee for the referral.

The onboard computer could also monitor whether the user selects any of the advertisements that the onboard computer has displayed to the user. The onboard computer can inform the server or monitoring service of the advertisement selected by the user or displayed to the user. The server, accounting system, or monitoring service may then charge the advertiser a fee for the selection or display.

In a possible embodiment, a comparison specification of the replacement car and the current car may be delivered to a user. The comparison specification may include, but is not limited to: percentage increase or decrease of the engine capacity, percentage increase or decrease of the horsepower of the replacement car over the current car, percentage increase or decrease of the torque of the replacement car over the current car, benefit of the type of the replacement car vs. the current car, etc.

In another example scenario, a user interacts with a cellular phone with respect to a 2007 XYZ automobile. The cellular telephone has access to the Internet and a server (for example, like server 10 described above) using a cellular communications link (e.g., 3G, 4G, CDMA, etc.). The user takes a picture, using the cellular phone, of the automobile's VIN. The user then initiates a search for a tire repair service for the automobile. The cellular phone sends the picture of the VIN number to the server and a request for a tire repair service.

The server receives the picture of the VIN number and the request for a tire repair service from the cellular phone. The server performs an OCR process on the picture and obtains the VIN number. The server uses the VIN number to search the database for the automobile information. The database returns the following information:

a. Type of Vehicle: 2007 XYZ brand sport coupe.

b. Operating System: Windows CE.

c. Horse Power: 300 horse power.

d. Engine: 6 cylinder, 3500 CC

The server then searches the database for a tire repair service center. The server may also search the database for advertisements for tire repair services. The server returns the search results for tire repair service centers (and possibly the advertisements from the advertisement search) to the cellular phone.

The cellular phone displays the tire repair service center search results to the user (and possibly any advertisements received from the server). The cellular phone can offer the user the option of selecting a tire repair service center and displaying directions and/or a map for the tire repair service center. The cellular phone can monitor which tire repair service center the user selects (possibly via monitoring the navigation system or the simple selection from the search results). The cellular phone can inform the server or a monitoring service of the tire repair service center selected by the user. The server, accounting system, or monitoring service may then charge the tire repair service center a fee for the referral.

The cellular phone could also monitor whether the user selects any of the advertisements that the onboard computer has displayed to the user. The cellular phone can inform the server or monitoring service of the advertisement selected by the user or displayed to the user. The server, accounting system, or monitoring service may then charge the advertiser a fee for the selection or display.

For the purposes of illustration, merchandise information have been used in the examples below, but can be substituted with any information from the following information group consisting of: merchandise information (including, but not limited to: the information or the price information related to a vehicle or an auto part, information or price information related to a mobile device, information or price information related to an object equipped with a computer, information or price information related to a component or a tool to build an object equipped with a computer), advertisement information (including, but not limited to: advertisement information or on sale information related to a vehicle or an auto part, advertisement information or on sale information related to a mobile device or an accessory of a mobile device, advertisement information or on sale information related to an object equipped with a computer, information of on sale information related to a service to an object equipped with a computer (e.g., an auto repair service, etc.)), and service information (including, but not limited to: service information, repair information, or service/repair labor cost information related to a vehicle, service information or wireless plan service related to a mobile device, service information, repair information, or service/repair labor cost information related to an object equipped with a computer).

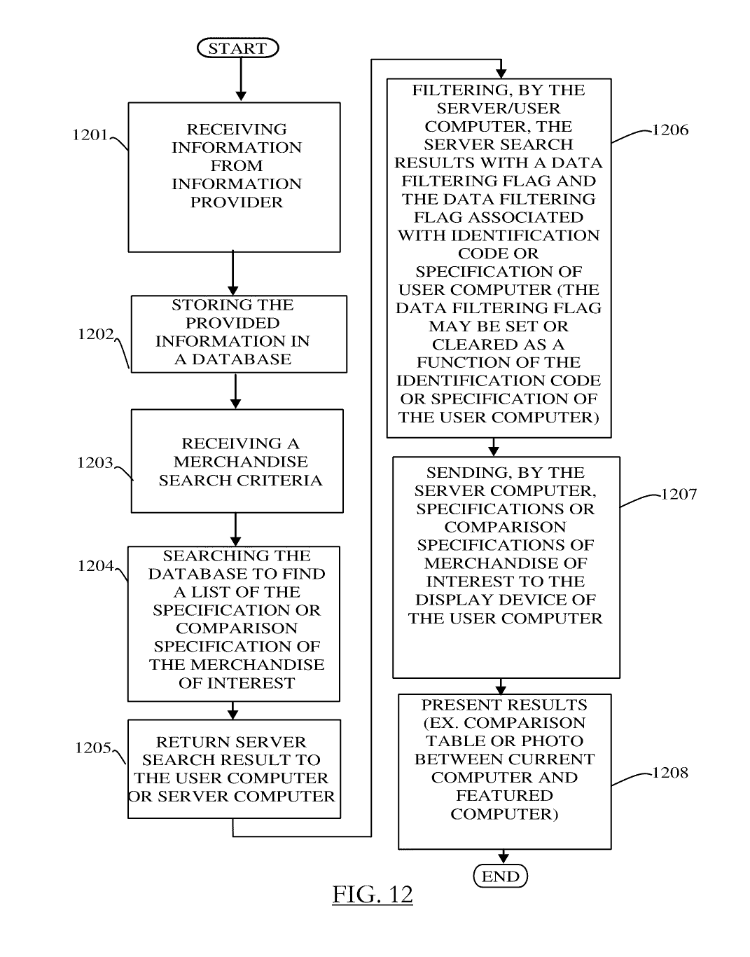

Referring to FIG. 12, an example process flow chart is shown illustrating a server performing filtering of merchandise search result in order to find merchandise related to a computing device's ID or specification.

At step 1201, the server 10 or a database manager receives computer device and merchandise object information from computer device/merchandise manufacturers, distributors, retailers, etc., via an Internet connection, phone line, radio frequency link, etc. The computer device information includes information needed to populate the database with computer ID and specification information. The computer device and merchandise information may be any combination of: manufacturer specification, operation system specification, micro processor speed specification, memory size specification, memory type specification, dimension specification, weight specification, color specification, style specification, wireless subscription plan specification, network connection speed specification, network connection type specification, display technology specification, display size specification, display resolution specification, software revision specification, connection coverage availability specification, connection technology specification, battery type specification, camera resolution quality specification, ability to customized specification, keyboard type specification, GPS availability specification, etc.

The computer ID and specification information is correlated with merchandise object information by the server 10. Server 10 can perform the correlation using local memory or can store the information (step 1202) in data structures, such as tables, in database 14. A comparison specification database, comparing the specification between the provided merchandise information, may be generated.

At step 1203, server 10 receives search criteria such as merchandise search criteria from a user's computer. The server 10 queries database 14 using the search criteria (step 1204). Database 14 finds any merchandise matches the search criteria, for example, candidate cellular phones, car chargers, cellular phone cases, earphones, vehicle, etc.

At step 1205, the server 10 receives the search results after the search of the database 14. Alternatively, the user's computer receives the search results from the server 10 after the search of the database 14

At step 1206, the search results may be filtered by a mechanism on the server 10 (or, alternatively, on the user's computer) as a function of the user's computing device's ID or specification. For example, the server search results can be filtered with the following requirement: only objects with more than a 10% microprocessor speed increase over the user's computer remain in the final/display dataset that is sent to the user computer for display.

The server search results may be filtered by a mechanism as a function of the user computing device's ID or specification. For example, the server search results can be filtered by the following requirement: only merchandise with more than a 10% increase in microprocessor speed over the user's computer remain in the final/display dataset that is displayed to the user. Thus, an additional step to FIG. 8 may be added—server search results may be filtered by a mechanism as a function of the user computing device's ID or specification. The server search results may be filtered by a display flag. The display flag can be set, by the server, for example, if the microprocessor speed of the comparison specification or specification of the computer merchandise of interest is greater than 10% faster than the user's current computer's microprocessor speed. This may be implemented by a conditional and compare function to generate the final/display dataset.

In a possible process flow, the server 10 formats the information according to the user's computer ID or specification. In this example, the merchandise computer with a 10% faster speed than the speed of the user computer's microprocessor speed can be displayed to the user, due to the cookie being set by the server 10. The “10% faster speed than the speed of the user computer's microprocessor speed” can be the condition for display.

In a possible process flow, the user's computer formats the display information according to the user's computer ID or specification. This may be implemented by display control software, such as a browser, that generates a cookie and/or retrieves a cookie, with the cookie being a function of the user computer's ID or specification. The information to be displayed in the user computer's display monitor can be a function of the user computer's ID or specification. In this example, the merchandise computer with a 10% faster speed than the speed of the user computer's microprocessor speed can be displayed to the user, due to the cookie being set by the server 10. The “10% faster speed than the speed of the user computer's microprocessor speed” can be the condition for display.

At step 1207, the server 10 sends, as a function of the specification or identification code of the user's computer, the specifications or comparison specifications of the merchandise to the user's computer. Alternatively, the user's computer has previously formatted the display information.

At step 1208, the user's computer receives the message from the server 10 and displays the search results to the user. Alternatively, the user's computer has previously formatted the display information. The user's computer may format a screen using the search results, display a bitmapped page, display an HTML page, etc. In a possible embodiment, the user can purchase any of the merchandise shown in the search results by clicking on a purchase button near the merchandise description. In a possible embodiment, a link (e.g., URL, hyperlink, etc.) may be displayed along with the merchandise description that the user may click on to obtain more information about the merchandise.

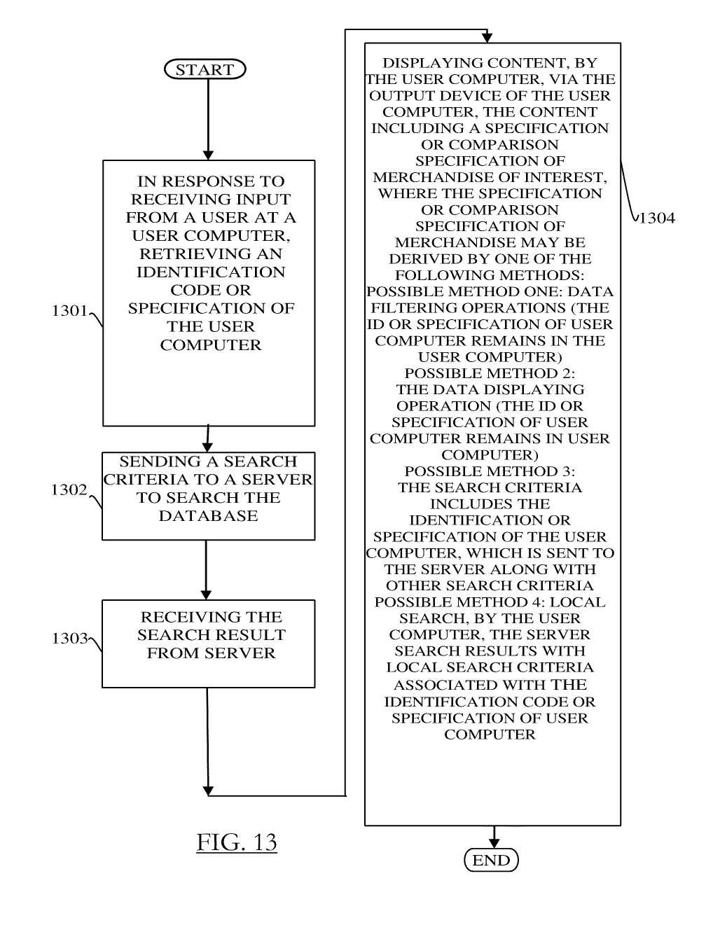

Referring to FIG. 13, an example process flow chart is shown illustrating a user computer performing filtering of merchandise search result in order to find merchandise related to a computing device's ID or specification.

The server search results may be filtered, by a mechanism as a function of the user computing device's ID or specification. For example, the server search results can be filtered by the following requirement: only merchandise with more than a 10% increase in microprocessor speed remain in the final/display dataset that is displayed to the user. The server search results may be filtered by a display flag. The display flag can be set, by the server, for example, if the microprocessor speed of the comparison specification or specification of the computer merchandise of interest is greater than 10% faster than the user's current computer's microprocessor speed. This may be implemented by a conditional and compare function to generate the final/display dataset.

In a possible process flow, the server 10 formats the user's display and/or displays the information according to the user's computer ID or specification. This may be implemented by display control software, such as a browser, that generates a cookie and/or retrieves a cookie, with the cookie being a function of the user computer's ID or specification. The information to be displayed in the user computer's display monitor can be a function of the user computer's ID or specification. In this example, the merchandise computer with a 10% faster speed than the speed of the user computer's microprocessor speed can be displayed to the user, due to the cookie being set by the server 10. The “10% faster speed than the speed of the user computer's microprocessor speed” can be the condition for display.

At step 1301, the user computer 30 in response to a user interaction, retrieves the identification code or specification from any of: memory, disk, device, or microprocessor.

At step 1302, the user computer 30 sends search criteria to the server to search a database for information that user is looking for.

At step 1303, the user computer 30 receives the search results from server computer. The return search results may include a specification criteria.

At step 1304, the user computer 30 displays, as a function of the specification or identification code of the user computer, the specifications or comparison specifications of the merchandise to the user's outputting device. Four example process flows are as follows:

1. The final/display dataset can be generated at the user's computer. The server search results may be filtered, by a mechanism as a function of the user computing device's ID or specification. For example, the server search results can be filtered by the following requirement: only objects with more than a 10% increase over the microprocessor speed of the user's computer increase will be remain in the final/display dataset that will be display to the user's display. The server search results may be filtered by a display flag. The display flag can be set, by the server, for example, if the microprocessor speed of the comparison specification or specification of the computer merchandise of interest is greater than 10% faster than the user's current computer's microprocessor speed. This may be implemented by a conditional and compare function to generate the final/display dataset.

2. The display dataset may not be generated and data display operation may be needed. The user computer 30 formats the user's display 35 and/or displays the information according to the user's computer ID 37 or specification. This may be implemented by display control software, such as a browser, that generates a cookie and/or retrieves a cookie, while the cookie is a function of the user's computer ID 37 or specification. The information to be displayed on the user's computer display is a function of the user's computer ID 37 or specification. In this example, the microprocessor speed of the merchandise with 10% faster speed than the speed of the user computer's microprocessor speed can be displayed to the user, due to the cookie being set by the user computer 30 or server computer 10.

3. A second search step may be added. The second search step searches the searching results returned from server, based on the user computer ID 37 or specification. Hence, the most relevant search result, a comparison specification or a specification of the merchandise of interest, may be output to the output device of the user computer.

In this case, the ID or specification of the user computer remains in the user computer. The user computer does not send user computer related data to the server in order to prevent any privacy issues—the server does not have a copy of user's device record.

4. The user computer 30 displays the specification or comparison specification of the merchandise of interest from the search results received from server on the display 35 of the user computer. The search criteria, along with the ID or specification of the user computer, may be sent to the server computer by default. In this case, at step 1302, the search criteria contain the ID or specification of the user computer. At step 1303, the specification or comparison specification of the merchandise of interest is received from server. At step 1304, the results are set to the output device of the user computer.

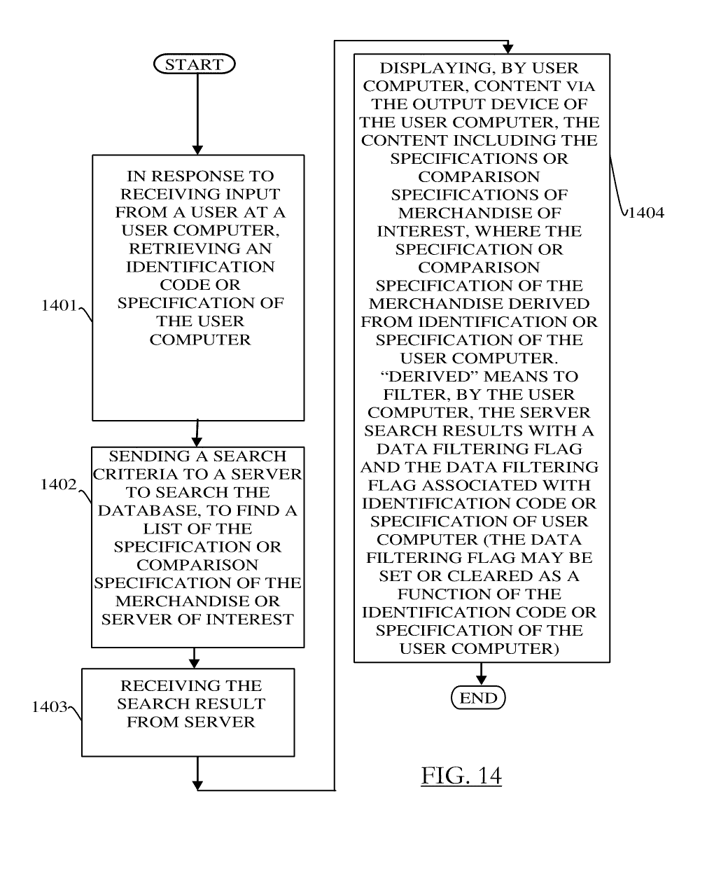

Referring to FIG. 14, an example process flow chart is shown further illustrating the first example process flow of FIG. 13.

At step 1401, the user computer 30, in response to a user interaction, retrieves the identification code or specification from any of: memory, disk space, device, or a microprocessor.

At step 1402, the user computer 30 sends search criteria to the server to search a database for information that user is looking for.

At step 1403, the user computer 30 receives the search results from server computer. This search results may include a specification criteria of computer merchandise.

At step 1404, the user computer 30 displays, as a function of the specification or identification code of the user computer, the specifications or comparison specifications of the merchandise on the user computer's display device.

The server search results may be filtered, by a mechanism as a function of the user computing device's ID or specification. For example, the server search results can be filtered by the following requirement: only merchandise with more than a 10% increase in microprocessor speed remain in the final/display dataset that is displayed to the user. The server search results may be filtered by a display flag. The display flag can be set, by the server, for example, if the microprocessor speed of the comparison specification or specification of the computer merchandise of interest is greater than 10% faster than the user's current computer's microprocessor speed. This may be implemented by a conditional and compare function to generate the final/display dataset.

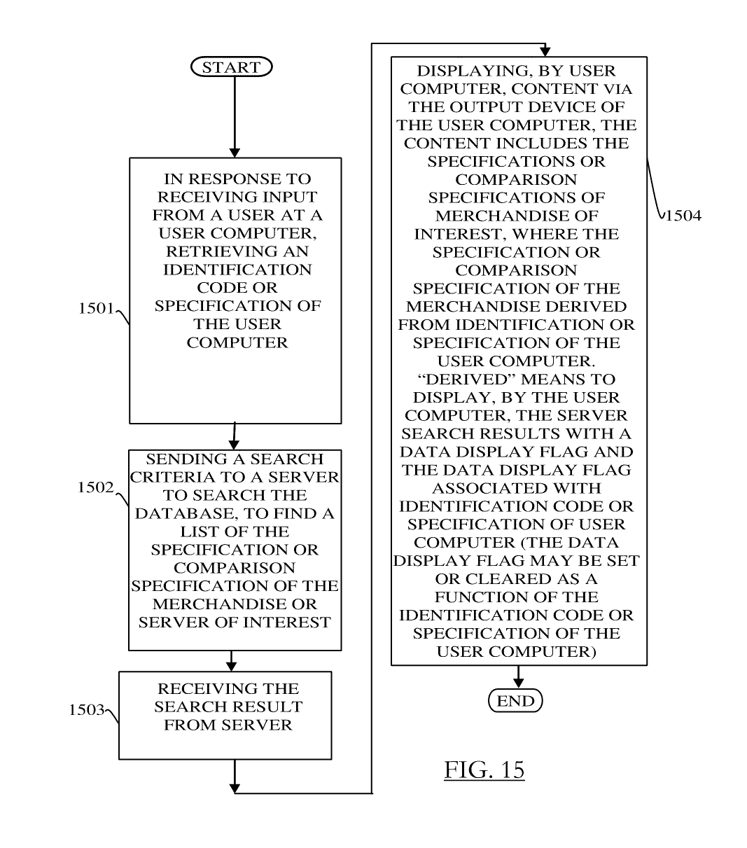

Referring to FIG. 15, an example process flow chart is shown further illustrating the second example process flow of FIG. 13.

At step 1501, the user computer 30, in response to a user interaction, retrieves the identification code or specification from any of: memory, disk space, device, or a microprocessor.

At step 1502, the user computer 30 sends search criteria to the server to search a database for information that user is looking for.

At step 1503, the user computer 30 receives the search results from server computer. This search results may include a specification criteria of computer merchandise.

At step 1504, the user computer 30 displays, as a function of the specification or identification code of the user computer, the specifications or comparison specifications of the merchandise on the user computer's display device.

At step 1504, the display dataset may not be generated and data display operation may be needed. The user computer 30 formats the user's display 35 and/or displays the information according to the user's computer ID 37 or specification. This may be implemented by display control software, such as a browser, that generates a cookie and/or retrieves a cookie, while the cookie is a function of the user's computer ID 37 or specification. The information to be displayed on the user's computer display is a function of the user's computer ID 37 or specification. In this example, the microprocessor speed of the merchandise with 10% faster speed than the speed of the user computer's microprocessor speed can be displayed to the user, due to the cookie being set by the user computer 30.

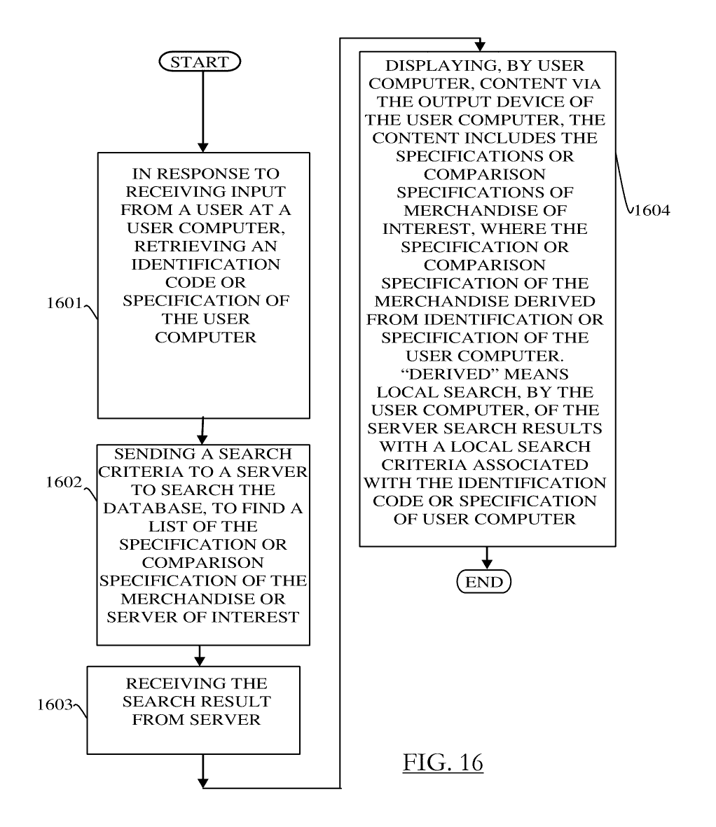

Referring to FIG. 16, an example process flow chart is shown further illustrating the third example process flow of FIG. 13.

At step 1601, the user computer 30, in response to a user interaction, retrieves the identification code or specification from any of: memory, disk space, device, or a microprocessor.

At step 1602, the user computer 30 sends search criteria to the server to search a database for information that user is looking for.

At step 1603, the user computer 30 receives the search results from server computer. This search results may include a specification criteria of computer merchandise.

At step 1604, the user computer 30 displays, as a function of the specification or identification code of the user computer, the specifications or comparison specifications of the merchandise on the user computer's display device.

At step 1604, second search step may be added. The second search step searches the searching results returned from server, based on the user computer ID 37 or specification. Hence, the most relevant search result, a comparison specification or a specification of the merchandise of interest, may be output to the output device of the user computer.

The ID or specification of the user computer remains in the user computer. The user computer does not send user computer related data to the server in order to prevent any privacy issues—the server does not have a copy of user's device record.

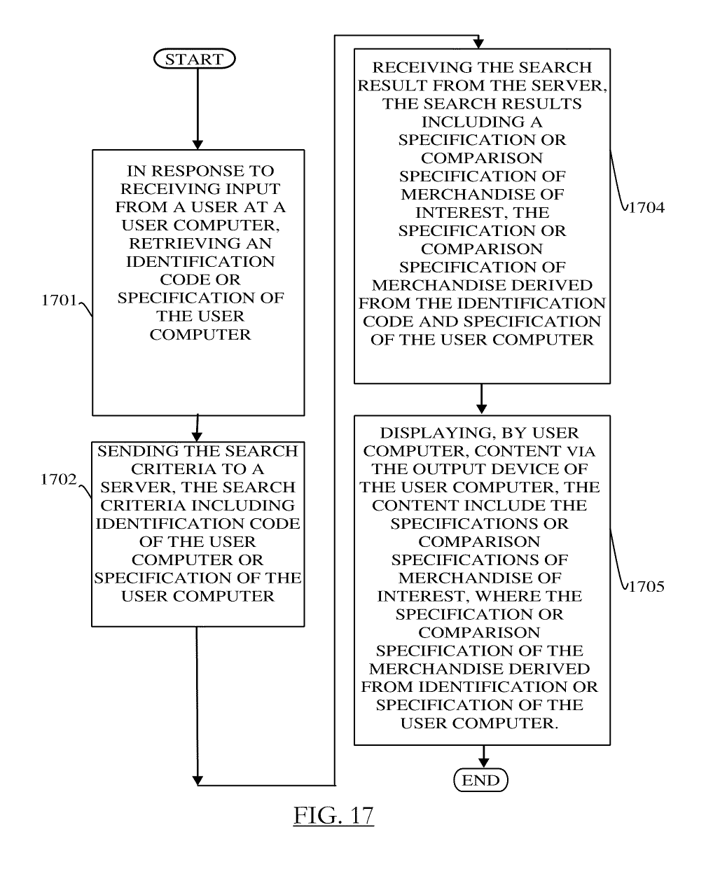

Referring to FIG. 17, an example process flow chart is shown further illustrating the fourth example process flow of FIG. 13.

At step 1701, the user computer 30, in response to a user interaction, retrieves the identification code or specification from any of: memory, disk space, device, or a microprocessor.

At step 1702, the user computer 30 sends search criteria to the server to search a database for information that user is looking for.

At step 1703, the user computer 30 receives the search results from server computer. This search results may include a specification criteria of computer merchandise.

At step 1704, the user computer 30 displays, as a function of the specification or identification code of the user computer, the specifications or comparison specifications of the merchandise on the user computer's display device.

At step 1704, the user computer 30 displays the specification or comparison specification of the merchandise of interest from the search results received from server on the display 35 of the user computer. The search criteria, along with the ID or specification of the user computer, may be sent to the server computer by default. In this case, at step 1702, the search criteria contain the ID or specification of the user computer. At step 1703, the specification or comparison specification of the merchandise of interest is received from server. At step 1704, the results are set to the output device of the user computer.

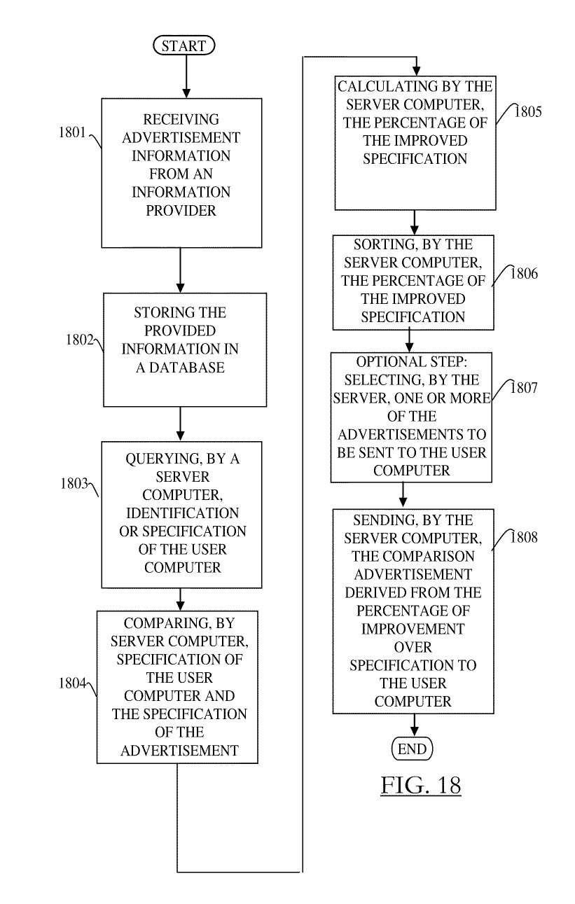

Referring to FIG. 18, an example process flow chart is shown illustrating a server delivering advertisement information related to a computing device's ID or specification. At step 1801, the server 10 or a database manager receives computer device and advertisement information from computer device/merchandise/advertisement manufacturers, distributors, retailers, etc. The computer device advertisement information includes advertisement information needed to populate the database with computer ID and specification information.

The server 10 receives computer device and merchandise object information from computer device/merchandise manufacturers, distributors, retailers, etc., via an Internet connection, phone line, radio frequency link, etc. The computer device and advertisement information may be any combination of: manufacturer specification advertisement, operation system specification advertisement, microprocessor speed specification advertisement, memory size specification advertisement, memory type specification advertisement, dimension specification advertisement, weight specification advertisement, color specification advertisement, style specification advertisement, wireless subscription plan specification advertisement, network connection speed specification advertisement, network connection type specification advertisement, display technology specification advertisement, display size specification advertisement, display resolution specification advertisement, software revision specification advertisement, connection coverage availability specification advertisement, connection technology specification advertisement, battery type specification advertisement, camera resolution quality specification advertisement, ability to customize specification advertisement, keyboard type specification advertisement, GPS availability specification advertisement, etc.

The computer ID and specification information is correlated with advertisement object information received from the computer device/merchant/advertisement manufacturers, distributors, retailers, etc., by the server 10. Server 10 can perform the correlation using local memory or can store the information (step 1802) in data structures, such as tables, in database 14.

At step 1803, server 10 queries the user's computer to receive information such as an ID code for the user's computer or a specification of the user's computer from the user's computer.

At step 1804, the server 10 compares the user computer's specification with the specification of the advertisement merchandise. In a possible embodiment, the server 10 selects the advertisement having merchandise with a better specification than the specification of the user computer.

At step 1805, the server 10 calculates the percentage of improvement from the specification of the advertisement merchandise vs. the specification of the user's computer. For example, the server 10 lists all of the advertisement merchandise computers that have a 10% faster microprocessor speed than the user's computer.

At step 1806, the server 10 sorts the list with the target specifications, possibly by the speed of the microprocessor or the percentage of improvement of the specification over the user's computer.

At step 1807, an optional step, the server 10 selects advertisements from the sorted list.

At step 1808, server 10 sends the sorted list of advertisements to the user's computer.

For example, server 10 queries the database for the ID or specification of the user's computer and sends the correlated comparison specification advertisement to the user's computer. The server 10 can follow the process flow as described in FIG. 18, or by other process flows, such as, where the server 10 sends the corresponding advertisement, after the server 10 acquires the user computer's ID or specification. For example, the server 10, can compare, calculate the percentage of the improvement, and/or sort all of the specifications of the advertisement merchandise provided by the information provider. This comparison specification of the advertisements may be stored in a database. The correlated advertisements may be sent to the user computer's display device by the user's computer.

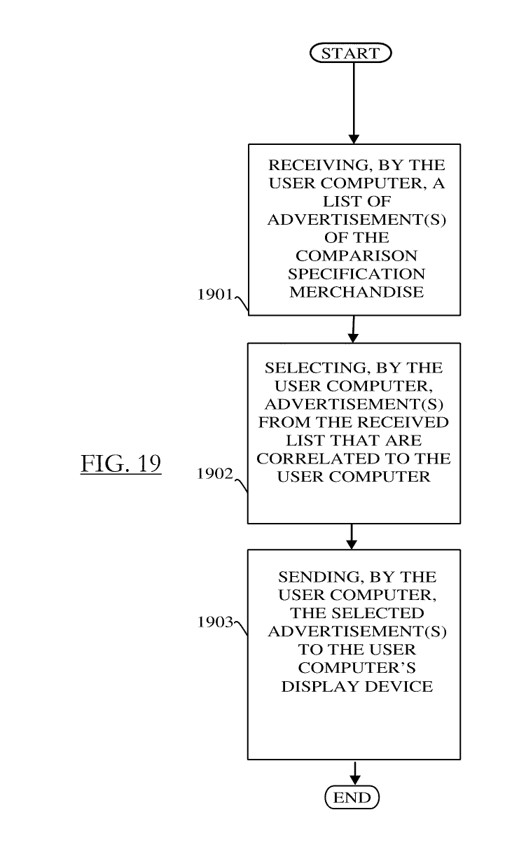

Referring to FIG. 19, the server 10 sends a list of advertisement(s) of comparison specifications to the user computer. The server 10, compares, calculates, and sorts all the specifications of the advertisement merchandise provided by the information provider and stores the comparison specifications of the advertisement merchandise in a database. The user's computer 30 selects a corresponding advertisement which is correlated to the user computer ID or specification. The selected advertisement may be sent to the user computer's display device by the user's computer.

At step 1901, the user's computer receives a list of the advertisement(s) of the comparison specifications of the merchandise.

At step 1902, the user's computer selects the advertisement(s) from the received list of the advertisements that correspond to the user's computer specification or ID.

At step 1903, the user computer sends the selected advertisement(s) to the display device of the user's computer.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

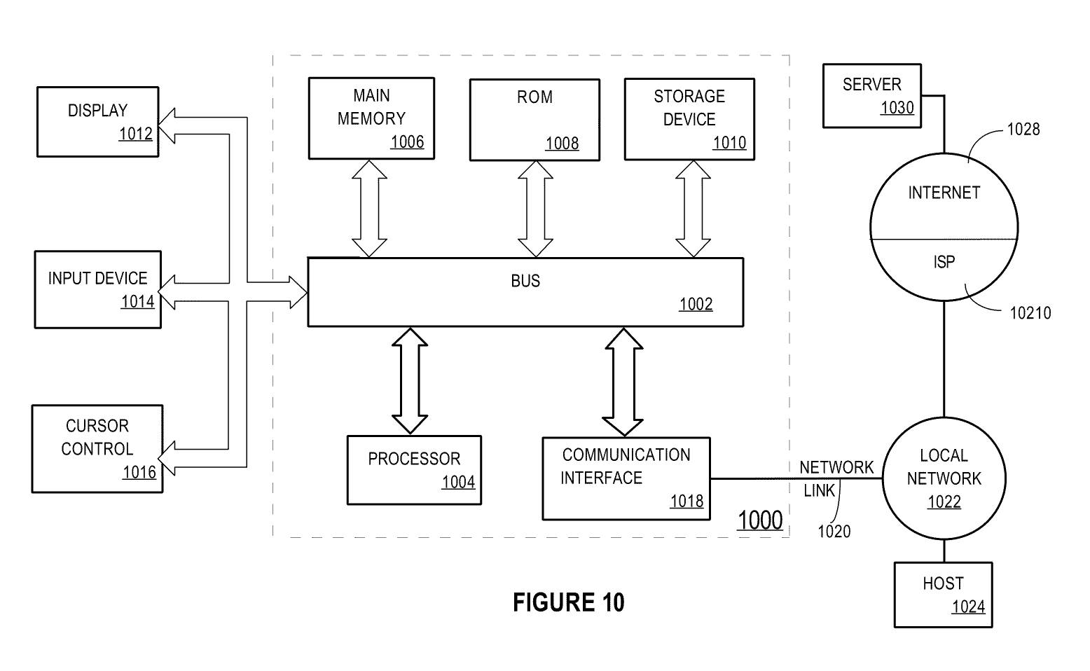

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### EQUIVALENTS, EXTENSIONS, ALTERNATIVES AND MISCELLANEOUS

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method of accessing information comprising:
receiving, at a server, information from an information provider;
storing the received information in a database, the received information including an identifier of at least one merchandise and description of the at least one merchandise;
receiving, by the server, a search criteria from a user computer of a plurality of user computers, the search criteria including at least an identification code of the user computer;
processing, by the server, the identification code of the user computer to obtain a specification of the user computer;
searching the database, by the server, for information that matches a description of merchandise of interest, the description of merchandise of interest derived from the specification of the user computer;
sending results from the search to the user computer.

2. The method of claim 1, wherein the user computer is any of: a mobile device, a personal computer, a workstation computer, an ebook computer, and a mobile gaming device.

3. The method of claim 1, wherein the identification code of the user computer is any of: string of codes, Internet Protocol address, Media Access Control address, host name, International Mobile Subscriber Identity, Temporary Mobile Subscriber Identity, International Mobile Equipment Identity, Mobile Equipment Identifier, Type Allocation Code, string of ASCII characters, serial number, FCC ID, and model number.

4. The method of claim 1, wherein the specification of merchandise is any of: manufacturer specification, operation system specification, microprocessor speed specification, memory size specification, memory type specification, dimension specification, weight specification, color specification, style specification, wireless subscription plan specification, network connection speed specification, network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

5. The method of claim 1, wherein the specification of the user computer is any of: manufacturer specification, operating system specification, microprocessor speed specification, memory size specification, memory type specification, dimension specification, weight specification, color specification, style specification, wireless subscription plan specification, network connection speed specification, network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

6. The method of claim 1, wherein the search results include a specification of a computing device.

7. The method of claim 1, wherein the search results include a pictorial depiction of the user computer and a computing device.

8. The method of claim 1, wherein the server charges an advertiser a fee for sending an advertisement to the user computer.

9. The method of claim 1, wherein the search results include a price of a computing device.

10. The method of claim 1, wherein a user initiates sending the search criteria from the user computer to the server.

11. The method of claim 1, further comprising:
receiving a user's selection of one or more merchandise from the search results;
adding the one or more selected merchandise to an electronic shopping checkout system.

12. The method of claim 11, wherein the one or more merchandise is selected from the following group: a computing device and a mobile device accessory.

13. The method of claim 12, wherein the computing device is a mobile device.

14. The method of claim 13, wherein the mobile device is a cellular phone device or an ebook.

15. The method of claim 12, wherein the mobile device accessory can be selected from the following group of: a headset, case, pouch, or mobile device charger.

16. The method of claim 1, further comprising:
including, in the search results, a price and availability of merchandise in the search results;
accepting user input selection of a quantity of each of the merchandise for purchasing;
transferring the selected quantity of each of the selected merchandise to a network shopping basket;
accepting user input to purchase the selected quantity of each of the selected merchandise;
notifying the user of the completion of the purchase.

17. A non-transitory computer readable medium comprising a sequence of instructions, which when executed by one or more processors, cause performing steps of:
receiving, at a server, information from an information provider;
storing the received information in a database, the received information including an identifier of at least one merchandise and description of the at least one merchandise;
receiving, by the server, a search criteria from a user computer of a plurality of user computers, the search criteria including at least an identification code of the user computer;
processing, by the server, the identification code of the user computer to obtain a specification of the user computer;
searching the database, by the server, for information that matches a description of merchandise of interest, the description of merchandise of interest derived from the specification of the user computer;
sending results from the search to the user computer.

18. The non-transitory computer readable medium of claim 17, wherein the user computer is any of: a mobile device, a personal computer, a workstation computer, an ebook computer, and a mobile gaming device.

19. The non-transitory computer readable medium of claim 17, wherein the identification code of the user computer is any of: string of codes, Internet Protocol address, Media Access Control address, host name, International Mobile Subscriber Identity, Temporary Mobile Subscriber Identity, International Mobile Equipment Identity, Mobile Equipment Identifier, Type Allocation Code, string of ASCII characters, serial number, FCC ID, and model number.

20. The non-transitory computer readable medium of claim 17, wherein the specification of merchandise is any of: manufacturer specification, operation system specification, microprocessor speed specification, memory size specification, memory type specification, dimension specification, weight specification, color specification, style specification, wireless subscription plan specification, network connection speed specification, network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

21. The non-transitory computer readable medium of claim 17, wherein the specification of the user computer is any of: manufacturer specification, operating system specification, microprocessor speed specification, memory size specification, memory type specification, dimension specification, weight specification, color specification, style specification, wireless subscription plan specification, network connection speed specification, network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

22. The non-transitory computer readable medium of claim 17, wherein the search results include a specification of a computing device.

23. The non-transitory computer readable medium of claim 17, wherein the search results include a pictorial depiction of the user computer and a computing device.

24. The non-transitory computer readable medium of claim 17, wherein the server charges an advertiser a fee for sending an advertisement to the user computer.

25. The non-transitory computer readable medium of claim 17, wherein the search results include a price of a computing device.

26. The non-transitory computer readable medium of claim 17, wherein a user initiates sending the search criteria from the user computer to the server.

27. The non-transitory computer readable medium of claim 17, further comprising:
receiving a user's selection of one or more merchandise from the search results;
adding the one or more selected merchandise to an electronic shopping checkout system.

28. The non-transitory computer readable medium of claim 27, wherein the one or more merchandise is selected from the following group: a computing device and a mobile device accessory.

29. The non-transitory computer readable medium of claim 28, wherein the computing device is a mobile device.

30. The non-transitory computer readable medium of claim 29, wherein the mobile device is a cellular phone device or an ebook.

31. The non-transitory computer readable medium of claim 28, wherein the mobile device accessory can be selected from the following group of: a headset, case, pouch, or mobile device charger.

32. The non-transitory computer readable medium of claim 17, further comprising:
including, in the search results, a price and availability of merchandise in the search results;
accepting user input selection of a quantity of each of the merchandise for purchasing;
transferring the selected quantity of each of the selected merchandise to a network shopping basket;
accepting user input to purchase the selected quantity of each of the selected merchandise;
notifying the user of the completion of the purchase.

33. An apparatus of accessing information comprising:
a device, at a server, that receives information from an information provider;
a device that stores the received information in a database, the received information including an identifier of at least one merchandise and description of the at least one merchandise;
a device, at a server, that receives a search criteria from a user computer of a plurality of user computers, the search criteria including at least an identification code of the user computer;
a device, at a server, that processes the identification code of the user computer to obtain a specification of the user computer;
a device, at a server, that searches the database for information that matches a description of merchandise of interest, the description of merchandise of interest derived from the specification of the user computer;
a device, at a server, that sends results from the search to the user computer.

34. The apparatus of claim 33, wherein the user computer is any of: a mobile device, a personal computer, a workstation computer, an ebook computer, and a mobile gaming device.

35. The apparatus of claim 33, wherein the identification code of the user computer is any of: string of codes, Internet Protocol address, Media Access Control address, host name, International Mobile Subscriber Identity, Temporary Mobile Subscriber Identity, International Mobile Equipment Identity, Mobile Equipment Identifier, Type Allocation Code, string of ASCII characters, serial number, FCC ID, and model number.

36. The apparatus of claim 33, wherein the specification of merchandise is any of: manufacturer specification, operation system specification, microprocessor speed specification, memory size specification, memory type specification, dimension specification, weight specification, color specification, style specification, wireless subscription plan specification, network connection speed specification, network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

37. The apparatus of claim 33, wherein the specification of the user computer is any of: manufacturer specification, operating system specification, microprocessor speed specification, memory size specification, memory type specification, dimension specification, weight specification, color specification, style specification, wireless subscription plan specification, network connection speed specification, network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

38. The apparatus of claim 33, wherein the search results include a specification of a computing device.

39. The apparatus of claim 33, wherein the search results include a pictorial depiction of the user computer and a computing device.

40. The apparatus of claim 33, wherein the server charges an advertiser a fee for sending an advertisement to the user computer.

41. The apparatus of claim 33, wherein the search results include a price of a computing device.

42. The apparatus of claim 33, wherein a user initiates sending the search criteria from the user computer to the server.

43. The apparatus of claim 33, further comprising:
a device, at a server, that receives a user's selection of one or more merchandise from the search results;
a device, at a server, that adds the one or more selected merchandise to an electronic shopping checkout system.

44. The apparatus of claim 43, wherein the one or more merchandise is selected from the following group: a computing device and a mobile device accessory.

45. The apparatus of claim 44, wherein the computing device is a mobile device.

46. The apparatus of claim 45, wherein the mobile device is a cellular phone device or an ebook.

47. The apparatus of claim 44, wherein the mobile device accessory can be selected from the following group of: a headset, case, pouch, or mobile device charger.

48. The apparatus of claim 33, further comprising:
a device that includes, in the search results, a price and availability of merchandise in the search results;
a device that accepts user input selection of a quantity of each of the merchandise for purchasing;
a device that transfers the selected quantity of each of the selected merchandise to a network shopping basket;
a device that accepts user input to purchase the selected quantity of each of the selected merchandise;
a device that notifies the user of the completion of the purchase.

49. A method of accessing information comprising:
in response to receiving input from a user at a user computer, retrieving an identification code of the user computer or object that the user computer is associated with;
sending, by the user computer, search criteria to a server, the search criteria including at least the identification code of the user computer or object that the user computer is associated with;
receiving, by the user computer, search results from the server, the search results including a description of merchandise of interest derived from the identification code of the user computer or the object that the user computer is associated with;
displaying, by the user computer, the search results to a user on a display communicatively connected to the user computer.

50. The method of claim 49, wherein the search results include a specification of a computing device or a replacement object.

51. The method of claim 49, wherein the search results include a comparison specification of one or more computing devices or one or more replacement objects.

52. The method of claim 51, wherein selection of the one or more computing devices or the one or more replacement objects in the comparison specification is based on a percentage of improvement over the user computer.

53. The method of claim 49, wherein the search results include comparison advertisements for one or more computing devices or for one or more replacement objects.

54. The method of claim 53, wherein selection of the one or more computing devices or the one or more replacement objects in the comparison advertisements is based on a percentage of improvement over the user computer.

55. The method of claim 49, wherein the search results include a pictorial depiction of the user computer and a computing device or the object that the user computer is associated with and a replacement object.

56. The method of claim 49, wherein the search results include a price of a computing device or a replacement object.

57. The method of claim 49, further comprising:
reporting, by the user computer, to the server, any advertisements in the search results that the user views or selects.

58. The method of claim 49, further comprising:
reporting, by the user computer, to the server, any links in the search results that the user views or selects.

59. A non-transitory computer readable medium comprising a sequence of instructions, which when executed by one or more processors, cause performing steps of:
in response to receiving input from a user at a user computer, retrieving an identification code of the user computer or object that the user computer is associated with;
sending, by the user computer, search criteria to a server, the search criteria including at least the identification code of the user computer or object that the user computer is associated with;
receiving, by the user computer, search results from the server, the search results including a description of merchandise of interest derived from the identification code of the user computer or the object that the user computer is associated with;
displaying, by the user computer, the search results to a user on a display communicatively connected to the user computer.

60. The non-transitory computer readable medium of claim 59, wherein the search results include a specification of a computing device or a replacement object.

61. The non-transitory computer readable medium of claim 59, wherein the search results include a comparison specification of one or more computing devices or one or more replacement objects.

62. The non-transitory computer readable medium of claim 61, wherein selection of the one or more computing devices or the one or more replacement objects in the comparison specification is based on a percentage of improvement over the user computer.

63. The non-transitory computer readable medium of claim 59, wherein the search results include comparison advertisements for one or more computing devices or for one or more replacement objects.

64. The non-transitory computer readable medium of claim 63, wherein selection of the one or more computing devices or the one or more replacement objects in the comparison advertisements is based on a percentage of improvement over the user computer.

65. The non-transitory computer readable medium of claim 59, wherein the search results include a pictorial depiction of the user computer and a computing device or the object that the user computer is associated with and a replacement object.

66. The non-transitory computer readable medium of claim 59, wherein the search results include a price of a computing device or a replacement object.

67. The non-transitory computer readable medium of claim 59, further comprising:
reporting, by the user computer, to the server, any advertisements in the search results that the user views or selects.

68. The non-transitory computer readable medium of claim 59, further comprising:
reporting, by the user computer, to the server, any links in the search results that the user views or selects.

69. An apparatus of accessing information comprising:
a device, at a user computer, that, in response to receiving input from a user, retrieves an identification code of the user computer or object that the user computer is associated with;
a device, at a user computer, that sends search criteria to a server, the search criteria including at least the identification code of the user computer or the object that the user computer is associated with;
a device, at a user computer, that receives search results from the server, the search results including a description of merchandise of interest derived from the identification code of the user computer or the object that the user computer is associated with;
a device, at a user computer, that displays the search results to a user on a display communicatively connected to the user computer.

70. The apparatus of claim 69, wherein the search results include a specification of a computing device.

71. The apparatus of claim 69, wherein the search results include a comparison specification of one or more computing devices or one or more replacement objects.

72. The apparatus of claim 71, wherein selection of the one or more computing devices or the one or more replacement objects in the comparison specification is based on a percentage of improvement over the user computer.

73. The apparatus of claim 69, wherein selection of the one or more computing devices or the one or more replacement objects in the comparison specification is based on a percentage of improvement over the user computer.

74. The apparatus of claim 73, wherein the search results include comparison advertisements for one or more computing devices or for one or more replacement objects.

75. The apparatus of claim 69, wherein the search results include a pictorial depiction of the user computer and a computing device or the object that the user computer is associated with and a replacement object.

76. The apparatus of claim 69, wherein the search results include a price of a computing device or a replacement object.

77. The apparatus of claim 69, further comprising:
a device, at a user computer, that reports to the server, any advertisements in the search results that the user views or selects.

78. The apparatus of claim 69, further comprising:
a device, at a user computer, that reports to the server, any links in the search results that the user views or selects.

79. A method of accessing information comprising:
in response to receiving input from a user at a user computer, sending search criteria to a server, the search criteria including search terms for objects that the user is interested in;
receiving, by the user computer, search results from the server, the search results including a description of merchandise of interest;
retrieving, by the user computer, an identification code of the user computer or object that the user computer is associated with;
filtering the search results using the identification code of the user computer or the object that the user computer is associated with;
displaying, by the user computer, the filtered search results to a user on a display communicatively connected to the user computer.

80. The method of claim 79, wherein the search results include a specification of a computing device or a replacement object.

81. The method of claim 79, wherein the search results include a comparison specification of one or more computing devices or one or more replacement objects.

82. The method of claim 81, wherein selection of the one or more computing devices or the one or more replacement objects in the comparison specification is based on a percentage of improvement over the user computer.

83. The method of claim 79, wherein the search results include comparison advertisements for one or more computing devices or for one or more replacement objects.

84. The method of claim 83, wherein selection of the one or more computing devices or the one or more replacement objects in the comparison advertisements is based on a percentage of improvement over the user computer.

85. The method of claim 79, wherein the search results include a pictorial depiction of the user computer and a computing device or the object that the user computer is associated with and a replacement object.

86. The method of claim 79, wherein the search results include a price of a computing device or a replacement object.

87. The method of claim 79, further comprising:
reporting, by the user computer, to the server, any advertisements in the search results that the user views or selects.

88. The method of claim 79, further comprising:
reporting, by the user computer, to the server, any links in the search results that the user views or selects.

89. A non-transitory computer readable medium comprising a sequence of instructions, which when executed by one or more processors, cause performing steps of:
in response to receiving input from a user at a user computer, sending search criteria to a server, the search criteria including search terms for objects that the user is interested in;
receiving, by the user computer, search results from the server, the search results including a description of merchandise of interest;
retrieving, by the user computer, an identification code of the user computer or object that the user computer is associated with;
filtering the search results using the identification code of the user computer or the object that the user computer is associated with;
displaying, by the user computer, the filtered search results to a user on a display communicatively connected to the user computer.

90. The non-transitory computer readable medium of claim 89, wherein the search results include a specification of a computing device or a replacement object.

91. The non-transitory computer readable medium of claim 89, wherein the search results include a comparison specification of one or more computing devices or one or more replacement objects.

92. The non-transitory computer readable medium of claim 91, wherein selection of the one or more computing devices or the one or more replacement objects in the comparison specification is based on a percentage of improvement over the user computer.

93. The non-transitory computer readable medium of claim 89, wherein the search results include comparison advertisements for one or more computing devices or for one or more replacement objects.

94. The non-transitory computer readable medium of claim 93, wherein selection of the one or more computing devices or the one or more replacement objects in the comparison advertisements is based on a percentage of improvement over the user computer.

95. The non-transitory computer readable medium of claim 89, wherein the search results include a pictorial depiction of the user computer and a computing device or the object that the user computer is associated with and a replacement object.

96. The non-transitory computer readable medium of claim 89, wherein the search results include a price of a computing device or a replacement object.

97. The non-transitory computer readable medium of claim 89, further comprising:
reporting, by the user computer, to the server, any advertisements in the search results that the user views or selects.

98. The non-transitory computer readable medium of claim 89, further comprising:
reporting, by the user computer, to the server, any links in the search results that the user views or selects.

99. An apparatus of accessing information comprising:
a device, at a user computer, that, in response to receiving input from a user at a user computer, sends search criteria to a server, the search criteria including search terms for objects that the user is interested in;
a device, at a user computer, that receives search results from the server, the search results including a description of merchandise of interest;
a device, at a user computer, that retrieves an identification code of the user computer or object that the user computer is associated with;
a device, at a user computer, that filters the search results using the identification code of the user computer or the object that the user computer is associated with;
a device, at a user computer, that displays the filtered search results to a user on a display communicatively connected to the user computer.

100. The apparatus of claim 99, wherein the search results include a specification of a computing device.

101. The apparatus of claim 99, wherein the search results include a comparison specification of one or more computing devices or one or more replacement objects.

102. The apparatus of claim 101, wherein selection of the one or more computing devices or the one or more replacement objects in the comparison specification is based on a percentage of improvement over the user computer.

103. The apparatus of claim 99, wherein the search results include comparison advertisements for one or more computing devices or for one or more replacement objects.

104. The apparatus of claim 103, wherein selection of the one or more computing devices or the one or more replacement objects in the comparison advertisements is based on a percentage of improvement over the user computer.

105. The apparatus of claim 99, wherein the search results include a pictorial depiction of the user computer and a computing device or the object that the user computer is associated with and a replacement object.

106. The apparatus of claim 99, wherein the search results include a price of a computing device or a replacement object.

107. The apparatus of claim 99, further comprising:
a device, at a user computer, that reports to the server, any advertisements in the search results that the user views or selects.

108. The apparatus of claim 99, further comprising:
a device, at a user computer, that reports to the server, any links in the search results that the user views or selects.
